(19) United States
(12) Patent Application Publication
(10) Pub. No.: US 2008/0118647 A1
(43) Pub. Date: May 22, 2008

(54) Process For Producing Ink Jet Recording Material

(75) Inventors: Shigeru Suzuki, Tokyo (JP); Mitsuru Kobayashi, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: OJI PAPER CO., LTD., Tokyo (JP)

(21) Appl. No.: 11/576,686

(22) PCT Filed: Oct. 4, 2005
(86) PCT No.: PCT/JP05/18368

§ 371 Date: Dec. 7, 2007

(30) Foreign Application Priority Data
Oct. 6, 2004 (JP) 2004-294296

(51) Int. Cl. B05D 3/12

(52) U.S. Cl. 427/362

(57) ABSTRACT

The present invention relates to a process for producing an ink jet recording material, comprising sequentially forming an ink-receptive layer and a glossy layer on a low air-permeable or air-impermeable support or a solvent-absorptive layer superimposed on the support, characterized in that the glossy layer is formed by applying a coating liquid for a glossy layer, the coating liquid comprising a cationic fine pigment and a cationic emulsion type adhesive, followed by pressing using a glossy roll and a press roll while making a surface of a resultant coating liquid layer contact with the glossy roll.

### TECHNICAL FIELD

The present invention relates to a process for producing an ink jet recording material, and particularly relates to a process for producing an ink jet recording material in which a resin-coated paper or a resin film is used as a support.

The present invention claims priority on Japanese Patent Application No. 2004-294296 filed on Oct. 6, 2004, the contents of which are incorporated herein by reference.

### BACKGROUND ART

An ink jet recording system in which aqueous ink is ejected through a fine nozzle to produce an image on a recording material is widely used in a terminal printer, facsimile, plotter, form printer, or the like, due to its low noise during recording, ease of producing full-color images, possibility of performing high-speed recording, lower cost than other printers, and so forth.

In recent years, high-level characteristics of a recording material to be used in the ink jet recording system are required so as to meet rapid spread, enhanced detail, and speedup of a printer, and also to meet an appearance of a digital camera. That is, an ink jet recording material which can realize high-speed ink absorption, high recording density, excellent recording suitability such as water-resistance, storage durability, or the like, and particularly, which can realize an image quality equivalent to silver halide photography, surface gloss, and storage durability, has been strongly demanded.

On the other hand, an ink jet printer in which a pigment ink is used instead of a dye ink has been commercialized so as to realize storage durability of a printed image. In the case of the pigment ink, scratch resistance, which is not required in the case of the dye ink, pigment ink-fixing properties, and so forth, are not sufficiently realized, and so a recording material suitable for printing by such an ink jet printer using a pigment ink has been demanded.

In general, as a process for imparting luster gloss to an ink jet recording material, there is a process (calender finish) in which the surface of a coating layer is smoothed by passing the coating layer between pressurized or heated rolls using an apparatus such as a supercalender or the like. However, such a calender finish has a problem in which a recording material obtained by the calender finish exhibits insufficient luster gloss and decreased airspace of the coating layer, as a result of which ink absorbability is deteriorated and thereby ink blurring is easily caused.

In addition to such a calender finish, various processes in which an ink-receptive layer made of an ink-absorptive resin such as a starch, gelatin, water-soluble cellulose resin, polyvinyl alcohol, polyvinylpyrrolidone, modified polyurethane, or the like, is formed on the surface of a smooth and glossy plastic film or resin-coated paper (such as, for example, polyethylene laminated paper) so as to increase luster gloss have been proposed. However, recording materials obtained by such processes have problems in which ink-absorbability and ink-dryability thereof are insufficient, and thereby handling property thereof is not good, uneven ink-absorption easily occurs, and water resistance is also poor, although a certain degree of luster gloss is realized.

For example, processes in which a coating layer containing a fine particulate pigment such as a colloidal silica with a small average particle diameter as the main component thereof is formed has been proposed in Patent Documents 1 to 5. However, recording material prepared by such processes, although realizing a certain degree of luster gloss, cannot form sufficient airspaces in the coating layer, as a result of which a sufficient ink-absorbability cannot be realized, because it is formed using the fine particulate pigment.

Patent Document 4 discloses an ink jet recording sheet sequentially containing at least a support, a layer containing a fumed silica with an average primary particle diameter of 50 nm or less, and a layer containing a colloidal silica. However, although the glossiness is increased, the void thereof decreases due to the existence of primary particles such as colloidal silica, and thereby the ink-absorbability thereof easily deteriorates. When the coating amount is decreased so as to impart the ink-absorbability, a fringe pattern is produced, and thereby, the quality of the glossy surface is deteriorated, and sufficient luster gloss cannot be realized.

Patent Document 5 discloses an ink jet recording sheet sequentially including at least a support, a layer containing a fumed silica with an average primary particle diameter of 30 nm or less, and a layer containing cationic colloidal particles. Although image blurring with time after printing and water resistance are improved by using the cationic colloidal particles, there is a problem in which the ink-absorbability is deteriorated in the same way as that of Patent Document 4. That is, Patents Documents 1 to 5 make no suggestion for improving glossiness without deteriorating ink-absorbability as far as possible.

As another process for imparting luster gloss, a so-called cast coating process has been known in which a wet coating layer is brought into contact and pressed to the specular surface of a heated glossy roll, and then dried to copy the specular surface (see, for example, Patent Documents 6 and 7).

As the cast coating process, the following processes have been generally known:

(1) a wet casting process in which a pigment composition mainly containing a pigment and an adhesive is applied on a base paper, and then, while the resultant coating layer is in a wet state, the coating layer is brought into contact and pressed to the specular surface of a heated glossy roll, and then dried so as to produce a luster finish;
(2) a gelation casting process in which a coating layer in a wet state is gelated by applying an acid or salt or heating, and the gelated coating layer is brought into contact and pressed to a heated glossy roll, and then dried so as to produce a luster finish;
(3) a rewet casting process in which a coating liquid in a wet state is once dried, followed by wetting the dried coating layer again with a rewet liquid so as to be plasticized, bringing the coating layer into contact and pressing to a heated glossy roll, and then drying so as to produce a luster finish.

Although these cast coating process have been considered as separate techniques, they are common in that the surface of a coating layer in a wet state is brought into contact or pressed to a heated glossy roll (such as, for example, a casting drum), dried, and removed from the glossy roll so as to copy the specular surface.

Cast-coated paper prepared by such cast coating processes has a higher surface luster and superior surface smoothness, and realizes superior printing effects, in comparison with conventional recording materials subjected to calender finishing, and thereby, the cast-coated paper is mainly used for producing high-quality printing. However, such cast-coated paper causes various problems when used for an ink jet recording material.

For example, the above-mentioned cast-coated paper as disclosed in Patent Document 6 realizes high luster gloss by the presence of a film-forming substance such as an adhesive contained in a pigment composition composing a coating layer, the film-forming substance copying the surface of the glossy roll of a cast coater. However, the presence of the film-forming substance eliminates airspaces of the coating layer, and thereby the ink-absorption at the time of ink jet recording is significantly deteriorated.

Thus, it is important that the coating layer be made to be porous for the purpose of improving the ink-absorbability of the cast-coated paper.

However, on the other hand, when the coating layer is made to be porous, it becomes difficult to make a coating layer having a uniform film, which is required for producing an image with high-quality equivalent to silver halide photography without causing cracking of ink ejected from a fine nozzle of an ink jet printer.

That is, it is quite difficult for both uniformity free from cracking and porousness to be imparted to a film in accordance with conventional cast coating processes.

Since the cast-coated paper is dried by contacting a coating liquid in a wet state to a glossy roll, it is required that vapor converted from moisture contained in the coating liquid pass through to the rear side. Accordingly, when a significantly low air-permeable support such as a resin-coated paper or film is used, the vapor is retained inside the coating layer. Since the volume of the vapor is significantly greater that that of water before evaporation, the vapor which has nowhere to escape holds up the support. At this time, the weakest portion in the coating layer is destroyed. For example, when the coating layer is not sufficiently adhered to the specular surface of a heated glossy roll, the coating layer is separated from the surface of the glossy roll, and thereby, the specular surface of the glossy roll cannot be sufficiently copied, and a so-called insufficient adherence phenomenon is caused. On the other hand, when the adherence of the inside of an undried coating layer is weaker than the adherence between the glossy roll and the coating layer, the inside of the coating layer is destroyed, and thereby a part of the coating layer remains on the surface of the glossy roll and the glossy roll becomes dirty. In both cases, a satisfactory casting surface cannot be formed, and problems in quality and operationality occur. Accordingly, it is quite difficult to obtain a cast-coated paper using a low air-permeable or air-impermeable support such as a resin-coated paper or film.

Also, it is known that a defect called cockling is observed during ink jet recording in which the recording material is elongated and wrinkled due to the effect of solvent, such as moisture contained in ink. Cockling not only affects the appearance of printing matter but also makes the cockled recording material contact a recording head to stain the recording material. This may lead to breakage of the recording material or malfunction of the recording head. In order to prevent the generation of cockling, it is effective to use a support which is not enlarged by the solvent of ink, or to provide a layer between an ink-receptive layer and a support, which does not allow the solvent of ink to permeate. For example, if a low air-permeable or air-impermeable support, such as resin-coated paper or film, is used, cockling can be effectively prevented. However, it is quite difficult for a cast-coated paper to be produced using a low air-permeable or air-impermeable support as described above.

As a process for solving the above-mentioned problem, a process for forming a glossy layer, in which a step of applying a coating liquid for forming the glossy layer, the coating liquid containing a fine pigment; a step of pressing a layer of the coating liquid for forming the glossy layer against a glossy roll using a press roll; and a step of drying the layer of the coating liquid for forming the glossy layer are included can impart luster gloss to an ink jet recording material in which an ink-receptive layer containing a pigment and an adhesive is formed on a low air-permeable of air-impermeable support and the glossy layer containing a fine pigment and a release agent is formed on the ink-receptive layer, as disclosed in Patent Document 8.

However, when a pigment ink type ink jet printer is used for recording, there is a problem in which fixing-properties and scratch resistance of the pigment ink are poor.

(Patent Document 1) Japanese Unexamined Patent Application, First Publication No. H2-274587 (pages 1, 5, and 6)
(Patent Document 2) Japanese Unexamined Patent Application, First Publication No. H8-67064 (pages 2, 7, and 8)
(Patent Document 3) Japanese Unexamined Patent Application, First Publication No. H8-118790 (pages 2, 5, and 6)

### (Patent Document 4) Japanese Laid-Open Patent Application No. 2000-37944 (pages 2, 5, and 6)

### (Patent Document 5) Japanese Laid-Open Patent Application No. 2001-353957 (pages 2, 13, and 14)

(Patent Document 6) U.S. Pat. No. 5,275,846 (columns 9 and 18 to 20)
(Patent Document 7) Japanese Unexamined Patent Application, First Publication No. H7-89220 (pages 2 and 7 to 10)
(Patent Document 8) International Patent Publication No. WO 03/039881

### DISCLOSURE OF THE INVENTION

### Problems to be Solved by the Invention

An object of the present invention is to provide an ink jet recording material having a favorable white paper glossiness and surface quality equivalent to silver halide photography, excellent scratch resistance at a blank paper part, and excellent pigment-ink fixing-properties, by using a low air-permeable or air-impermeable support.

### Means for Solving the Problems

(1) A process for producing an ink jet recording material, including sequentially forming an ink-receptive layer and a glossy layer on a low air-permeable or air-impermeable support or a solvent-absorptive layer superimposed on the support, characterized in that the glossy layer is formed by applying a coating liquid for a glossy layer, the coating liquid including a cationic fine pigment and a cationic emulsion type adhesive, followed by pressing using a glossy roll and a press roll while making a surface of a resultant coating liquid layer contact with the glossy roll.

It is preferable that the coating liquid layer be dried without contacting the surface thereof to the glossy roll after pressing.

(2) A process for producing an ink jet recording material according to (I), wherein the cationic fine pigment is at least one selected from the group consisting of a cationized colloidal silica with an average primary particle diameter of 3 to 100 nm, a cationized fumed silica with an average primary particle diameter of 3 to 100 nm and an average secondary particle diameter of 1 μm or less, and a fumed alumina with an average primary particle diameter of 3 to 100 nm and an average secondary particle diameter of 1 μm or less.

### (3) A process for producing an ink jet recording material according to (1) or (2), wherein the cationic emulsion type adhesive has a minimum film-forming temperature of 20 to 110° C.

### (4) A process for producing an ink jet recording material according to any one of (1) to (3), wherein the cationic emulsion type adhesive has a particle diameter of 5 nm to 1000 nm.

(5) A process for producing an ink jet recording material according to any one of (1) to (4), wherein the cationic emulsion type adhesive is one or at least two copolymers selected from the group consisting of a (co)polymer of (meth)acrylic ester, a styrene resin, a styrene-(meth)acrylic ester (co)polymer, a methyl methacrylate-butadiene copolymer, a styrene-butadiene copolymer, a polyether-based urethane resin, a polyester-based polyurethane resin, a polycarbonate-based polyurethane resin, an epoxy-based resin, an ethylene-vinyl acetate copolymer, an ethylene-(meth)acrylate (co)polymer, a melamine-based resin, a urea-based resin, and an olefin-based resin.
(6) A process for producing an ink jet recording material according to any one of (1) to (5), wherein the glossy layer includes at least one release agent represented by the following general formula:

R₁—N⁺R₂R₃R₄X⁻ (General Formula)

(wherein R₁ represents an alkyl or alkenyl group having 10 to 18 carbon atoms, R₂, R₃, and R₄ each represents H or an alkyl group having 1 to 4 carbon atoms, and X⁻ represents F⁻, Cl⁻, Br⁻ or I⁻).

### (7) A process for producing an ink jet recording material according to any one of (1) to (6), wherein a coating amount of the glossy layer is within a range from 0.01 to 3 g/m².

### (8) A process for producing an ink jet recording material according to any one of (1) to (7), wherein the support is a resin-coated paper or a plastic film.

(9) A process for producing an ink jet recording material according to any one of (1) to (8), wherein the support is a resin-coated paper including: a paper base material; and resin layers formed on both surfaces of the paper base material, wherein end edges in a width direction of the paper base material and the resin layers are lined up on the same plane.

### (10) An ink jet recording material prepared by the process according to any one of (1) to (9).

### EFFECTS OF THE INVENTION

The ink jet recording material according to the present invention realizes favorable white paper glossiness and surface quality, equivalent to silver halide photography, and is excellent in printing density, scratch resistance at a blank paper part, and pigment-ink fixing-properties.

### BRIEF DESCRIPTION OF DRAWINGS

FIG. 1 is a cross-sectional view showing a resin-coated paper used in an aspect of the process for producing an ink jet recording material according to the present invention.

FIG. 2 is a cross-sectional view showing a laminated body used for producing the resin-coated paper shown in FIG. 1.

FIG. 3 is a schema showing a manufacturing apparatus used in an aspect of the process for producing an ink jet recording material according to the present invention.

### BRIEF DESCRIPTION OF THE REFERENCE SYMBOLS

1 INK JET RECORDING MATERIAL
2 SUPPORT
3 INK-RECEPTIVE LAYER
4 COATING LIQUID FOR GLOSSY LAYER
5 GLOSSY ROLL
6 PRESS ROLL
7 COATING LIQUID LAYER FOR GLOSSY LAYER
8 GLOSSY LAYER
9 DRIER
10 RESIN-COATED PAPER
10a LAMINATED BODY FOR RESIN-COATED PAPER
11 PAPER BASE MATERIAL
11a END EDGE (OF PAPER BASE MATERIAL)
12 RESIN LAYER
12a END EDGE (OF RESIN LAYER)

### BEST MODE FOR CARRYING OUT THE INVENTION

### (Support)

In the present invention, a low air-permeable or air-impermeable support means a support preferably having an air-permeability of 500 seconds or longer, or more preferably 1,000 seconds or longer. The air-permeability may be expressed by an air-permeability which is generally known as a parameter for evaluating porosity of paper or unwoven fabric. The air-permeability is expressed by a time required for 100 ml of air to pass through a test piece having a surface area of 645 mm², and this is specified in JIS P 8117 (“air-permeability testing method for paper and paperboard”).

As described above, in a conventional cast coating process, moisture contained in a coating liquid is vaporized and passed through a support to the rear side thereof when a cast coating layer is dried. Accordingly, a higher air permeability of a support used for cast coating is conventionally preferable. However, in the present invention, it is not necessary that the support be limited in terms of the air-permeability. On the contrary, it is preferable that the support not allow permeation of moisture or moisture vapor in order to prevent cockling. Accordingly, the material properties of the support used in the present invention are not particularly limited, provided that the support is a low air-permeable or air-impermeable member with a flat and smooth surface.

Examples of a preferable support include: plastic films such as synthesized paper, typically “Yupo” (manufactured by Yupo Corporation), the synthesized paper being obtained by drawing cellophane, polyethylene, polypropylene, soft polyvinyl chloride, hard polyvinyl chloride, polyester (such as, for example, PET), or polypropylene, followed by being subjected to a special process; and resin-coated paper in which the surface of a base material, such as paper, is coated with a resin, such as a polyethylene resin, a polypropylene resin, or the like. Among them, use of the synthesized paper or polyethylene resin-coated paper, and more preferably use of resin-coated paper in which the surface of paper is coated with a polyethylene resin containing titanium oxide is preferable due to its finishing appearance equivalent to photographic paper.

The synthesized paper can be generally prepared by extruding a polypropylene resin containing an inorganic pigment such as calcium carbonate, followed by performing biaxial orientation so as to form airspaces inside of the resultant. It is preferable that the synthesized paper be a laminated sheet composed of plural layers. In particular, synthesized paper having an even surface skin on which an ink-receptive layer is to be formed is preferably used. Examples thereof include those manufactured by Yupo Corporation under the trade names of GWG series and GFG series.

For the case in which the support is resin-coated paper, the thickness of a resin layer is not particularly limited. When a paper coated with a polyethylene resin is used, for example, the thickness of the polyethylene resin layer is preferably 3 to 50 μm, and more preferably 5 to 40 μm. If the thickness of the polyethylene layer is less than 3 μm, defects, such as holes, tend to be easily caused in the polyethylene resin layer during the resin coating process. Also, it becomes difficult to control the thickness, and smoothness is hardly obtained. If the thickness exceeds 50 μm, on the other hand, obtained effects are small with respect to necessary cost, and it is not economically effective.

In addition, various layers such as an anchor layer, a primer layer, an antistatic layer, or the like may be formed on the surface of the support in order to improve coating suitability or charging property thereof.

Also, for the case where paper is used as a base material of resin-coated paper, one which is produced by using wood pulp as the main material thereof is preferably used as the paper base material. Various types of chemical pulp, mechanical pulp, and recycled pulp may be suitably used as the wood pulp, and the beating degree thereof may be controlled with a beating machine so as to adjust paper strength, smoothness, and suitability as paper, or the like, of the pulp. Although the beating degree is not particularly limited, it is preferable that the beating degree be within a range from about 250 to 550 mL (CSF: JIS-P-8121). Also, chlorine-free pulp, such as a so-called ECF and TCF pulp, may be preferably used. Moreover, a pigment may be added to the wood pulp, if necessary. As the pigment, a talc, calcium carbonate, clay, kaolin, sintered kaolin, silica, zeolite, or the like, may be preferably used. Although the degree of opacity and smoothness can be improved by adding the pigment, there is a case in which the paper strength is lowered by an excessive addition of pigment, and it is preferable that the added amount of the pigment be within a range of approximately 1 to 20% by mass of wood pulp.

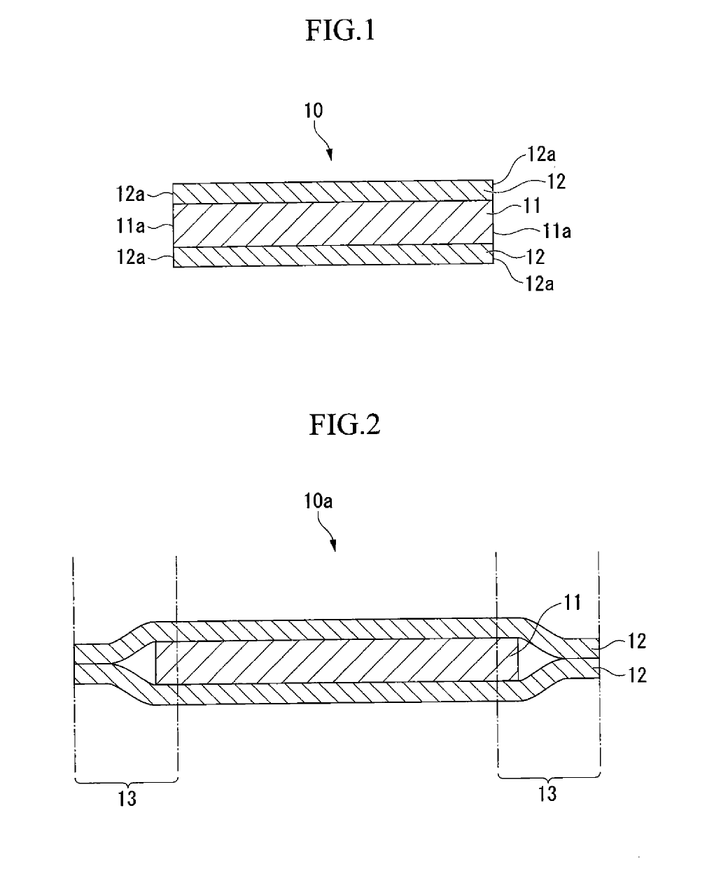

In the present invention, a cut-edge type resin-coated paper 10 in which resin layers 12, 12 are formed on both surfaces of a paper base material 11, and end edges 11a and 12a in a width direction of the paper base material 11 and the resin layers 12, 12, are lined up on the same plane, as shown in FIG. 1, may be used as the resin-coated paper.

In order to obtain the resin-coated paper 10 by making the end edges 11a and 12a in a width direction of the paper base material 11 and the resin layers 12 lined up on the same plane, resin layers 12, 12 with a width wider that that of the paper base material 11 are formed on both surfaces of the paper base material by an extrusion-coating method to obtain a laminated body 10a for resin-coated paper, as shown in FIG. 2, and then both end portions 13, 13 in a width direction of the paper base material 11 and the resin layers 12 of the laminated body 10a for resin-coated paper are cut along in a longitudinal direction and a direction parallel to a thickness direction, for example. In more detail, a heated and melted resin (heated at approximately 330° C., for example) is cast over the running paper base material 11 to form resin layers 12 on both surfaces of the paper base material 11 at once or one by one, and thus the laminated body 10a for resin-coated paper is obtained. At this time, the surface of the resin layer 12 may be made a luster surface, mat surface, or matte surface, using a cooling roll, in accordance with the intended purpose thereof. Then, the end portions 13, 13 in a width direction of the laminated body 10a for resin-coated paper are cut along in a longitudinal direction and a direction parallel to a thickness direction using a slitter or the like to make the end edges in a width direction of the paper base material 11 and the resin layers 12 lined up on the same plane.

### (Solvent-Absorptive Layer)

According to the present invention, although an ink-receptive layer may be formed on the support, it is preferable that a solvent-absorptive layer be formed between the support and the ink-receptive layer so as to increase the ink-absorbability. The solvent-absorptive layer formed on the support is a layer that instantaneously absorbs a solvent contained in ink and retains the solvent therein. The solvent-absorptive layer contains a pigment and a binder.

As the pigment, various well-known pigments may be used. For example, at least one of various pigments generally used for coating paper, such as silica, colloidal silica, kaolin, clay, sintered clay, zinc oxide, aluminum oxide, aluminum hydroxide, calcium carbonate, satin white, aluminum silicate, alumina, zeolite, synthesized zeolite, sepiolite, smectite, synthesized smectite, magnesium silicate, magnesium carbonate, magnesium oxide, diatomaceous earth, styrene-based plastic pigment, hydrotalcite, urea resin-based plastic pigment, benzoguanamine-based plastic pigment, or the like, may be used. Among these, wet silica, fumed silica, alumina, or zeolite is preferably used, and particularly wet silica is preferably used, due to their high ink-absorbability.

The wet silica is prepared from silicon dioxide (SiO₂), mainly using silica sand as a raw material, in accordance with a manufacturing method as typified by a gel method or precipitation method.

In order to obtain an amorphous silica by the gel method, for example, a silicate of soda, prepared using a high-pure silica sand as a raw material thereof, is mixed with sulfuric acid to obtain a silicate sol. The silicate sol gradually polymerizes to form primary particles and then form a three-dimensional aggregate, and thus is gelatinized. The obtained silica is finely pulverized to particles with micron size. That is, in accordance with the gel method, polymerization is carried out at an acid side, the resultant is left still until in a gel state (sherbet state), followed by washing it with water, and then drying to obtain the amorphous silica. In order to obtain the amorphous silica by the precipitation method, polymerization is carried out at an alkaline side and the resultant is precipitated, followed by drying the precipitate. The silica prepared by the gel method has a small pore size between the primary particles, while the silica prepared by the precipitation method has a large one.

In the present invention, use of the silica prepared by the gel method is particularly preferably due to its ink-absorbability and resistance to heat and humidity after printing. The reason for this is not clear, but it is supposed that the silica prepared by the gel method rapidly separates a solvent from a dye, both being contained in ink, and the ability of pores of the silica to retain the solvent therein is high. Although the average pore size of the silica particles is not particularly limited, it is preferable that the average pore size be, for example, 20 nm or less, and preferably 15 nm or less. It is preferable that the average particle diameter of the silica prepared by the gel method be 1 μm or less, more preferably 800 nm or less, and even more preferably 500 nm or less, in terms of the luster gloss or printing density.

The binder is not particularly limited. As the binder, various well-known adhesives generally used for coating paper can be used, and examples thereof include: water-soluble binders, such as, for example, polyvinyl alcohols such as polyvinyl alcohol, cationically modified polyvinyl alcohol, silyl modified polyvinyl alcohol, and the like, caseins, soy proteins, synthesized proteins, starches, cellulose derivatives such as carboxymethyl cellulose, methyl cellulose, and the like; water dispersible resins such as, for example, latexes of conjugated diene polymers such as styrene-butadiene copolymer, methyl methacrylate-butadiene copolymer, or the like, acrylic polymer latexes, latexes of vinyl polymers such as styrene-vinyl acetate copolymer, and the like. Among these, polyvinyl alcohol is preferably used due to its ability for absorbing a solvent contained in ink and for imparting water resistance to a coating film. Moreover, it is preferable that the polymerization degree thereof be 2000 or more and the saponification degree thereof be 95% or more, more preferably the polymerization degree be 4000 or more and the saponification degree be 98% or more, in view of balance between film-formability and ink-absorbability thereof. Also, other binders may be used in combination, if needed.

The content of the binder in the solvent-absorptive layer, with respect to 100 parts by mass of the inorganic pigment, is generally 25 parts by mass or less, preferably 7 parts by mass or more but 22 parts by mass or less, more preferably 8 parts by mass or more but 20 parts by mass or less. When the content of the binder is excessive, there is a case in which the size of pores formed between the pigments becomes small, and thereby, a high-ink absorption rate is not easily realized. On the contrary, when the content of the binder is inadequate, there is a case in which the solvent-absorptive layer is cracked.

The coating amount of the solvent-absorptive layer is generally approximately 3 to 100 g/m², and more preferably 3 to 50 g/m². As a coating method, well-known coating methods may be adopted. As a coating apparatus, various well-known coating apparatuses may be used, and examples thereof include a blade coater, air-knife coater, roll coater, bar coater, gravure coater, rod blade coater, lip coater, die coater, curtain coater, slide bead coater, and the like. The solvent-absorptive layer may be laminated in plural layers.

### (Ink-Receptive Layer)

An ink-receptive layer is formed on the support or the solvent-absorptive layer. The ink-receptive layer contains a pigment and an adhesive, and further contains a cationic compound, as needed. The ink-receptive layer is a layer that mainly fixes color materials of dye or pigment contained in ink.

The ink-receptive layer may be a single layer or multilayer. When the ink-receptive layer is a multilayer, the pigment or adhesive to be contained in each ink-receptive layer may be changed. For example, when the ink-receptive layer is a double layer in which an extremely fine pigment is contained in an ink-receptive layer (first layer), which contacts with a glossy layer, so as to increase luster gloss, and a pigment with a particle diameter greater than that of the ink-receptive layer (first layer) is contained in an ink-receptive layer (second layer), which contacts with the support or the solvent-absorptive layer, the ink-absorbability of the second layer is increased, and thereby both luster gloss and ink-absorbability can be maintained or improved, even if the ink-absorbability of the first layer is low.

It is preferable that the pigment contained in the ink-receptive layer be an inorganic pigment with an average particle diameter of 1 μm or less, more preferably 0.8 μm or less, and even more preferably 0.5 μm or less, the average particle diameter preferably being equivalent to or finer than that of the pigment contained in the solvent-absorptive layer. When the average particle diameter is 1 μm or less, the maximal value in the pore diameter distribution curve is at 100 nm or less, and thereby, a coating layer free from cracking is easily formed, favorable dot-reproducibility and ink-absorbability are realized, and the transparency of the ink-receptive layer is enhanced, as a result of which image recording density is high.

In this specification, the average particle diameter (average secondary particle diameter) is measured by stirring 5% silica dispersion using a homogenizing mixer rotated at 5,000 rpm for 30 minutes, applying the dispersion as a sample immediately after the mixing, observing the sample under electron microscope (SEM and TEM) to take an electron micrograph enlarged by ten thousand to four hundred thousand times, and measuring and averaging the Martin diameter of secondary particles within 5 square centimeters (refer to “Fine powder handbook”, Asakura-shoten, p. 52, 1991).

Also, although the specific surface area of the pigment is not particularly limited, it is preferable that the specific surface area be 150 m²/g or greater. Here, the specific surface area of the pigment means the surface area obtained by drying fine pigment at 105° C., measuring the nitrogen absorbing-desorbing isotherm of the obtained powder sample using the measuring device SA 3100, a product of Coulter Co., after vacuum degassing for two hours at 200° C., and calculating the specific surface area thereof using the t-method. The specific surface area is a surface area of fine pigment per mass, and the larger the value of the specific surface, the smaller the primary particle size thereof and the shape of secondary particle becomes complex. Accordingly, it is considered that the larger the specific surface area the greater the volume inside fine pores, and hence the ink absorptivity thereof is improved.

Examples of the inorganic pigment include transparent or white pigments, such as colloidal silica, amorphous silica, alumina, aluminum hydroxide, magnesium carbonate, calcium carbonate, kaolin, and sintered kaolin. These may be used alone or in combination of at least two kinds thereof.

Among them, at least one selected from the group consisting of fumed silica, mesoporous silica, colloidal matter of wet silica prepared by condensing active silica, alumina oxidative products, and alumina hydrates is preferably used. Among these, at least one selected from the group consisting of fumed silica, mesoporous silica, colloidal matter of wet silica prepared by condensing active silica is more preferably used. Among the alumina oxidative products, fumed alumina oxidative product is preferably used. In particular, fumed silica is preferably used.

In general, impurities are imparted to synthesized silica through a raw material thereof, such as metal ions, the raw material containing impurities, and also imparted to synthesized silica during preparation thereof. The synthesized silica containing a high level of impurities exhibits large refraction index, and thereby lacks transparency.

The purity of fumed silica can be relatively enhanced by distilling silicon tetrachloride as a raw material thereof. Also, the fumed silica can be prepared in a closed system by subjecting silicon tetrachloride to combustion hydrolysis in a gas phase, and thereby, mixing of impurities can be prevented during preparation thereof. When such a fumed silica with high purity is contained, high printing density and high luster gloss can be realized. Also, the fumed silica has a high-dispersibility, and so, can produce silica with an average particle diameter of approximately 100 to 800 nm in accordance with a well-known dispersion method.

The mesoporous silica is a silica madreporite with an average pore size of 1.5 to 100 nm. Also, mesoporous silica in which an aluminum, titanium, vanadium, boron, manganese, or other atom is incorporated may be used. The mesoporous silica is not particularly limited in terms of properties as madreporite, but it is preferable that BET specific surface area (nitrogen absorption specific surface area) be within a range form 200 to 1500 m²/g, and pore volume be within a range from 0.5 to 4 cc/g.

A process for synthesizing the mesoporous silica is not particularly limited, examples thereof include a synthesis process disclosed in U.S. Pat. No. 3,556,725 in which an alkoxide of silica is used as a source of silica and a quaternary ammonium salt containing a long chain alkyl is used as a template, a hydrothermal synthesis process disclosed in Published Japanese translation No. H5-503499 of PCT International Publication in which amorphous silica powders or an alkali-silicate aqueous solution is used as a source of silica and a quaternary ammonium salt or phosphonium salt containing a long chain alkyl group is used as a template, a synthesis process disclosed in Japanese Unexamined Patent Application, First Publication No. H4-238810 in which an ion-exchange process is performed using a layered silicate such as kanemite as a source of silica and a long-chain alkylammonium cation or the like as a template, a synthesis process in which an amine such as dodecylamine, hexadecyamine, or the like, a nonionic surfactant, or the like is used as a template, and an active silica prepared by subjecting a water glass or the like to ion-exchange is used as a source of silica, and the like. As a process for removing the template from an obtained nanoporous silica precursor, a process in which sintering is performed at a high temperature, a process in which extraction is performed using an organic solvent, or the like, may be used.

The colloidal matter of wet silica prepared by condensing active silica are dispersing secondary silica particles prepared by adding an alkali to a seed liquid in which silica disperses in a colloidal state, to which a feed liquid containing at least one selected from active silica aqueous solution and alkoxysilanes is gradually added for the growth of silica fine particles, as disclosed in Japanese Unexamined Patent Application, First Publication No. 2001-354408, for example.

The alumina oxidative product is also generally called an alumina oxide, which has crystallinity. Specific examples thereof include alumina oxides with χ, κ, γ, δ, θ, η, ρ, pseudo γ, or α crystal. In the present invention, a fumed alumina oxidative product, and aluminium oxide with γ, δ, θ crystal are preferable in terms of luster texture, and ink-absorbability. It is more preferable that the fumed alumina oxidative product (fumed alumina) exhibit a sharp particle size distribution and excellent film-formability, particularly.

The fumed alumina oxidative product is an alumina formed by hydrolyzing aluminum trichloride in a gas state at a high temperature, such a high temperature hydrolysis resulting in formation of alumina particles with high purity. The primary particle size of these particles is in a nano order, and exhibits an extremely narrow particle size distribution. Such a fumed alumina oxidative product has a surface with cationic charge. The use of the fined alumina oxidative product in an ink jet coating has been disclosed in U.S. Pat. No. 5,171,626, for example.

Although the alumina hydrate is not particularly limited, boehmite or pseudoboehmite is preferably selected in terms of ink-absorbability and film-formability. As a process for preparing alumina hydrate, a process in which aluminum isopropoxide is hydrolyzed with water (disclosed in B. E. Yoldas, Amer. Ceram. Soc. Bull., 54, 289 (1975) or the like), a process in which aluminum alkoxide is hydrolyzed (disclosed in Japanese Unexamined Patent Application, First Publication No. H06-064918, or the like) may be used, for example.

It is preferable that the average particle diameter of the silica or alumina be adjusted to 1 μm or less, more preferably 800 nm or less, and even more preferably 500 nm or less, so as to realize high printing density and high luster gloss. The average primary particle diameter is preferably within a range of approximately from 3 to 50 nm, and even more preferably from 5 to 40 nm.

Extremely fine particles with average particle diameter of 500 nm or less can be obtained by pulverizing and dispersing a pigment commercially available using a mechanical apparatus. Examples of the mechanical apparatus include an ultrasonic homogenizer, pressure-type homogenizer, liquid-liquid collision type homogenizer, rapidly-rotating mill, roller mill, container driven medium mill, medium stirring mill, jet mill, mortar, disintegrator (apparatus for grinding and kneading an object in a bowl-shaped container using a pestle-shaped stirring bar), sand grinder, and the like. The silica may be treated with a cationic compound to form a particle-composite composed of a cationic compound and a silica, and such a particle-composite is preferably used.

The adhesive contained in the ink-receptive layer is not particularly limited, and may be suitably selected from water-soluble resins such as polyvinyl alcohol, polyvinyl acetal, polyethylene imine, polyvinylpyrrolidone, polyacrylamide, and the like, and water dispersible resin such as acrylic polymer latexes, and latexes of vinyl polymers such as ethylene-vinyl acetate copolymer, or the like, for example. Among these, polyvinyl alcohol is preferably used because it can realize excellent coating strength.

When the polyvinyl alcohol is used, the polymerization degree thereof is preferably within a range from 1500 to 8000, and more preferably 2000 to 5000. When the polyvinyl alcohol of which the polymerization degree is within the above-mentioned range is used, cracking of the ink-receptive layer is suppressed, and swelling caused by a solvent contained in ink is also suppressed, as a result of which a decrease of the ink-absorption rate is suppressed. The saponification degree of the polyvinyl alcohol is preferably within a range from 80 to 100%, and more preferably 85 to 100%. When the saponification is less than 80%, there is a possibility in which the polyvinyl alcohol is swollen by a solvent contained in ink, and thereby, the ink-absorption rate decreases.

The content of the adhesive, with respect to 100 parts by mass of the pigment, is preferably within a range approximately from 3 to 100 parts by mass, and even more preferably approximately 5 to 30 parts by mass. When the content of the adhesive is less than 3 parts by mass, there is a possibility in which cracking of the ink-receptive layer easily occurs. When the content of the adhesive is more than 100 parts by mass, there is a possibility in which airspaces formed by the pigment are covered by the adhesive, and thereby the capacity of ink-absorption decreases.

A cationic compound may be contained in the ink-receptive layer, as needed, so as to fix a dye contained in ink, impart water resistance, and improve recording density, in a similar manner to that of a glossy layer circumstantially explained below. Examples thereof include: 1) polyalkylene polyamines such as polyethylene polyamine or polypropylene polyamine, and derivatives thereof; 2) acrylic polymers having a secondary amino group, tertiary amino group, or quaternary ammonium group; 3) polyvinylamines and polyvinylamidines; 4) dicyan-based cationic compounds exemplified by dicyandiamide-formalin copolymers; 5) polyamine-based cationic compounds exemplified by dicyandiamide-polyethyleneamine copolymers; 6) epichlorohydrin-dimethylamine copolymers; 7) diallyldimethyl ammonium-SO₂ polycondensation products; 8) diallylamine salt —SO₂ polycondensation products; 9) diallyldimethyl ammonium chloride polymers; 10) diallyldimethyl ammonium chloride-acrylamide copolymers; 11) copolymers of allylamine salts; 12) copolymers of alkoxy-modified polyallylamine and polyallylamine or salts thereof; 13) dialkylaminoethyl (meth)acrylate quaternary salt copolymers; 14) acrylamide-diallylamine copolymers; 15) cationic compounds such as cationic resins having a five-membered cyclic amidine structure, and the like.

Although the cationic compound may be contained not only in the ink-receptive layer but also in the above-mentioned solvent-absorptive layer, it is preferable that the solvent-absorptive layer be substantially free from the cationic compound but that the ink-receptive layer contain the cationic compound.

Since color materials contained in ink generally exhibit anionic properties, the color materials are easily fixed to a layer containing a cationic compound. As described above, the solvent-absorptive layer near to the support serves to absorb and retain therein a solvent contained in ink, and the ink-receptive layer near to a printing surface serves to hold therein the color materials contained in ink. It is effective that the color materials be effectively held in the ink-receptive layer so as to realize high printing density. When the solvent-absorptive layer is substantially free from the cationic compound, a cationic surfactant or the like may be contained therein in an extremely small amount as an auxiliary agent, or may be supplementarily distributed at an interface between the solvent-absorptive layer and the ink-receptive layer.

When the cationic compound is formulated with the pigment, the cationic compound may be mixed with the pigment. However, when the pigment is fine silica, in particular, there is a case in which fine silica particles agglomerate during mixing, because the fine silica generally exhibits anionic properties. In this case, the particle diameter thereof can be adjusted within the above-mentioned specific particle diameter by adopting a procedure in which a generally commercially available amorphous silica (with a secondary particle diameter of several micrometers) before pulverization is mixed and dispersed with a cationic compound, followed by pulverizing to fine particles and dispersing them by applying a strong force using a mechanical apparatus, or a procedure in which a cationic compound is added to and mixed with dispersing secondary silica particles finely pulverized to increase the viscosity of the mixture and to form agglomeration, and then the agglomeration is mechanically dispersed and pulverized again. The thus treated pigment has a structure in which the cationic compound is partially bonded and is in a slurry state in which stable dispersion is realized. Accordingly, if an additional cationic compound is separately added, it is difficult for the agglomeration to be formed. In the present invention, such a fine pigment treated with a cationic compound is referred to as a cationic fine pigment.

In order to disperse or pulverize the mixture or agglomeration of the pigment and the cationic compound, the above-mentioned mechanical apparatus is used. When the average secondary particle diameter exceeds 1000 nm, the mixture or the agglomeration can be sufficiently dispersed by applying a weak mechanical force using a homomixer. When the mixture or the agglomeration is pulverized to particles with an average secondary particle diameter of 1000 nm or less, application of a stronger mechanical force is effective, and a pressure-type dispersion process is preferably used.

In the present invention, the pressure-type dispersion process is a process in which a slurry mixture of raw particulate materials is pulverized at a high pressure by continuously passing the mixture through an orifice at a high pressure, the treatment pressure being preferably 19.6×10⁶ to 343.2×10⁶ Pa (200 to 3500 kgf/cm²), more preferably 49.0×10⁶ to 245.3×10⁶ Pa (500 to 2500 kgf/cm²), and even more preferably 98.1×10⁶ to 196.2×10⁶ Pa (1000 to 2000 kgf/cm²). The above-mentioned high-pressure pulverization realizes favorable dispersion or pulverization. Moreover, it is more preferable that dispersion or pulverization be conducted by passing the slurry mixture through the orifice at a high pressure to collide head-on with each other. In order to make the slurry mixture collide head-on, the dispersion is pressurized to direct it to an inlet side and divide it to flow into two passages, the flow rates thereof are enhanced by narrowing the flow passages using the orifice, and thus the dispersion is made to collide head-on so that particles are made to collide to pulverize them. As a material used for forming a portion in which the dispersion is accelerated or made to collide, diamond is preferably used due to its abrasion resistance or the like.

As a high pressure pulverizer, a pressure-type homogenizer, an ultrasonic homogenizer, a microfluidizer, or a NANOMIZER may be used, and the microfluidizer and the NANOMIZER are particularly preferable as a high speed colliding type homogenizer. The cationic fine pigments treated in such a way are generally obtained as an aqueous dispersion (a slurry or colloidal particles) with a solid concentration of approximately 5 to 20% by mass.

The cationic compound used for cationically treating the fine pigment is not particularly limited, and the above-mentioned cationic compounds may be suitably used. Among these, at least one selected from the group consisting of diallyldimethyl ammonium chloride polymers, diallyldimethyl ammonium chloride-acrylamide copolymers, copolymers of alkoxy-modified polyallylamine and polyallylamine or salts thereof, hydrochlorides of acrylamide-diallylamine copolymers, dicyandiamide-polyethylene amine copolymers, and cationic resins having a five-membered cyclic amidine structure is preferably used, because an excellent image which exhibits excellent color-developability and less bleeding is produced.

The content of the cationic compound, with respect to 100 parts by mass of the pigment, is preferably within a range from 1 to 30 parts by mass, and more preferably from 3 to 20 parts by mass. When the content of the cationic compound is less than 1 part by mass, it is difficult for an effect of improving printing density to be exhibited. On the contrary, when the content of the cationic compound is more than 30 parts by mass, there is a possibility in which an excess cationic compound covers airspaces, and thereby, the ink-absorbability deteriorates, and bleeding or unevenness of a produced image occurs.

Although it is preferable that the ink-receptive layer contain as little binder component as possible so as to impart absorbability, such a coating film is easily cracked during coating. In this case, cracking of a coating layer, the cracking being caused by hot air applied at a time of drying, can be prevented by increasing the viscosity of a coating liquid or gelating a coating liquid at an initial time of drying, for example.

Although a process for increasing the viscosity of an applied coating liquid or gelating an applied coating liquid is not particularly limited, examples thereof include a process in which the viscosity of a coating liquid is increased or the coating liquid is gelated using a cross-linking agent which can crosslink to a hydrophilic binder formulated in the coating liquid, a process in which the viscosity of a coating liquid is increased or the coating liquid is gelated by supplying energy such as electron beam or the like, a process in which the viscosity of a coating liquid is increased or the coating liquid is gelated by changing the temperature of a temperature-sensitive polymeric compound which exhibits hydrophilic property or hydrophobic property in accordance with temperature conditions thereof, the temperature-sensitive polymeric compound being used as a hydrophilic binder.

For example, in the process in which the viscosity of a coating liquid or a coating liquid is gelated using a cross-linking agent which can crosslink to a hydrophilic binder formulated in the ink-receptive layer, the above-mentioned hydrophilic binder and the cross-linking agent which can crosslink to the hydrophilic binder are used in combination. The cross-linking agent may be applied on and immersed in the solvent-absorptive layer, followed by applying a coating liquid for the ink-receptive layer thereon. Alternatively, the cross-linking agent may be formulated in a coating liquid for the ink-receptive layer, followed by applying the coating liquid. Alternatively, a coating liquid for the ink-receptive layer may be applied, followed by applying the cross-linking agent thereon. It is preferable that the cross-linking agent be applied in advance because an ink-receptive layer can be formed in which the viscosity-increase and gelation are uniformly performed.

Examples of the cross-linking agent include boron compounds, epoxy compounds, glycidyl compounds, zirconium compounds, aluminum compounds, chrome compounds, and the like. Among these, the boron compounds are particularly preferable, because the viscosity-increase or gelation rapidly proceeds when used in combination with polyvinyl alcohol. The boron compounds mean oxygen acids containing a boron atom as the central atom thereof or salts thereof. Examples thereof include an orthoboric acid, metaboric acid, hypoboric acid, tetraborate, and pentaborate, and sodium salts, potassium salts, and ammonium salts thereof. Among these, an orthoboric acid and disodium tetraborate are preferably used due to their effects of suitably increasing the viscosity of the coating liquid. It is preferable that the boron compound be contained on one surface of a base material in an amount of 0.01 to 1.5 g/m², although the preferable content of the boron compound depends on the kind of the boron compound and hydrophilic binder. When the content of the boron compound is more than 1.5 g/m², the cross-linking density thereof with the hydrophilic binder is increased, and thereby a coating film is so hard to be easily cracked. On the contrary, when the content of the boron compound is less than 0.01 g/m², the cross-linking thereof with the hydrophilic binder is weak, gelation of the coating liquid is also weak, and thereby a coating film is easily cracked.

In the process in which the viscosity of a coating liquid is increased or a coating liquid is gelated by supplying energy such as electron beam or the like, it is preferable that a hydrophilic binder free from any radically polymerizable unsaturated bonds, the hydrophilic binder forming a hydrogel by radiating electron beam to an aqueous solution thereof, be used as a binder of the ink-receptive layer, and a coating liquid containing the hydrophilic binder in an amount of 1 to 100 parts by mass, with respect to 100 parts by mass of the inorganic pigment, be applied, exposed to electron beam to make the applied coating liquid hydrogel, and then dried to form an ink-receptive layer.

Examples of the hydrophilic binder free from any radically polymerizable unsaturated bonds, the hydrophilic binder forming hydrogel by radiating electron beam to an aqueous solution thereof, include polyvinyl alcohol, polyethylene oxide, polyalkylene oxide, polyvinylpyrrolidone, water-soluble polyvinyl acetal, poly-N-vinylacetamide, polyacrylamide, polyacryloylmorpholine, polyhydroxyalkyl acrylate, polyacrylic acid, hydroxyethyl cellulose, methyl cellulose, hydroxypropyl methyl cellulose, hydroxypropyl cellulose, gelatin, and casein, water-soluble derivatives thereof, and copolymers thereof. These may be used alone or in combination. As a process for radiating electron beam, a scanning process, curtain beam process, broad beam process, or the like, may be adopted, for example. The suitable accelerating voltage at a time of radiating electron beam is approximately within a range from 50 to 300 kV. The irradiance level of electron beam is preferably adjusted within a range approximately from 1 to 200 kGy. Irradiation at an irradiance level of less than 1 kGy is insufficient to gelate a coating layer. On the contrary, irradiation at an irradiance level of more than 200 kGy may cause deterioration or discoloration of a base material or coating layer, and so is unfavorable. In the process in which the viscosity of a coating liquid is increased or the coating liquid is gelated by changing the temperature of a temperature-sensitive polymeric compound which exhibits hydrophilic property or hydrophobic property in accordance with temperature conditions thereof, the temperature-sensitive polymeric compound being used as a hydrophilic binder, it is preferable that a temperature-sensitive polymeric compound which exhibits a hydrophilic property in a temperature region lower than a temperature-sensitive point thereof, but exhibits a hydrophobic property in a temperature region higher than the temperature-sensitive point be used as a binder. When such a temperature-sensitive polymeric compound is used, it is preferable that coating be performed at a temperature higher than the temperature-sensitive point, followed by cooling at a temperature lower than the temperature-sensitive point, to make an applied coating layer gain an increased viscosity or be gelated, and then drying to form a recording layer. As such a temperature-sensitive polymeric compound, temperature-sensitive polymeric compounds disclosed in Japanese Laid-Open Patent Application, No. 2003-40916 in which polymerization is performed in coexistence of polyvinyl alcohol and/or polyvinyl alcohol derivatives are exemplified.

The ink-receptive layer is formed by applying a coating liquid in which components such as the above-mentioned pigment and the like are dispersed in a solvent on the solvent-absorptive layer, followed by drying. Although the solvent of the coating liquid is not particularly limited, water is preferably used in terms of coating suitability or the like.

As a coating apparatus, various well-known coating apparatuses such as a blade coater, air-knife coater, roll coater, bar coater, gravure coater, rod blade coater, lip coater, die coater, curtain coater, slide bead coater, or the like, may be used. In particular, the air-knife coater is preferably used because it can correspond with various coating physical properties or coating amounts. The die coater or curtain coater is particularly suitable for forming an ink jet recording material aiming at producing highly fine recording because it is excellent in realizing a uniform coating amount, and so is preferable.

A drying apparatus is not particularly limited, and various heating and drying processes conventionally well-known, such as hot-air drying, gas-heater drying, high-frequency drying, electric-heater drying, infrared-heater drying, laser drying, electron-beam drying, or the like, may be suitably adopted.

The ink-receptive layer may be composed of plural laminated layers. In this case, each of the laminated layers may be composed of a coating liquid with components identical to each other, or different from each other. It is preferable that the total coating amount thereof be within a range from 3 to 100 g/m², more preferably 3 to 80 g/m², and even more preferably 3 to 50 g/m². When the coating amount is less than 3 g/m², there is not only a possibility in which a glossy layer is not sufficiently formed, but also a case in which the ink-absorbability decreases, and recording suitability deteriorates. When the coating amount is more than 100 g/m², there is a possibility in which the strength of a coating liquid decreases and inconvenience easily occurs during cutting of the recording sheet or transporting a recording material using a printer.

The coating liquid for the ink-receptive layer may contain a release agent, as needed, so that the surface of a recording material can be smoothly and stably separated from a glossy roll, in a similar way to that of a glossy layer. Although the release agent will be circumstantially explained below, ones that can be contained in a glossy layer can be used. Different kinds of the release agent may be suitably selected to be contained in the glossy layer and the ink-receptive layer, and plural release agents may be used in combination.

In addition to the above, various auxiliary agents generally used for producing a coating sheet, such as various pigments, dispersants, thickeners, antifoamers, coloring agents, antistatic agents, antiseptic agents, or the like, may be suitably added to the coating liquid for ink-receptive layer.

### (Glossy Layer)

A glossy layer is formed by applying a coating liquid for the glossy layer containing a cationic fine pigment and a cationic emulsion type adhesive, followed by pressing using a glossy roll and a press roll while making a surface of a resultant coating liquid layer contact with the glossy roll. The surface of the coating liquid layer is dried at a drying step after pressing to form a glossy layer. When the fine pigment is pressed, fine unevenness of the surface of the ink-receptive layer is smoothed, and thereby a high luster gloss is imparted to a recording material. Also, the surface strength is improved and an excellent scratch resistance is imparted to the recording material by coexistence of the adhesive with fine particle structure. Moreover, the luster gloss of the recording material is further enhanced by pressing it while making the surface thereof contact with the glossy roll to smooth the surface.

Examples of the cationic fine pigment include transparent or white pigments such as cationized colloidal silica, cationized fumed silica, fumed alumina, and the like. Among the fine pigments treated with the cationic compound, exemplified as a component of the ink-receptive layer, the cationized finned silica refers to one in which finned silica is used as a pigment.

The luster gloss is improved by using the cationized colloidal silica. It is preferable that the average primary particle diameter of the cationized colloidal silica be within a range from 3 to 100 nm, more preferably 10 to 80 nm, and even more preferably 20 to 70 nm. When the average particle diameter is less than 3 nm, there is a case in which the ink-absorbability deteriorates. When the average particle diameter is greater than 100 nm, the printing density tends to decrease because the transparency decreases.

When the cationized fumed silica or the fumed alumina is used, it is preferable that the average primary particle diameter thereof be within a range from 3 to 100 nm, and more preferably 3 to 40 nm. Also, it is preferable that the average secondary particle diameter of the cationized fumed silica or the fumed alumina be 1 μm or less, and more preferably within a range from 10 to 700 nm.

Among these, it is particularly preferable that at least one selected from the group consisting of cationized fumed silica with an average primary particle diameter of 3 to 100 nm and an average secondary particle diameter of 1 μm or less, and fumed alumina with an average primary particle diameter of 3 to 100 nm and an average secondary particle diameter of 1 μm or less be contained in the glossy layer, because the pigment-ink fixing-properties are improved.

### (Cationic Adhesive)

Examples of the cationic emulsion type adhesive composed of particles of a water-insoluble thermoplastic resin with a cationic functional group such as an amino group include: (co)polymers of (meth)acrylic ester; styrene resins; styrene-(meth)acrylic ester (co)polymers; methyl methacrylate-butadienes copolymers; styrene-butadiene copolymers; polyether-based urethane resins; polyester-based polyurethane resins; polycarbonate-based polyurethane resins; epoxy-based resins; ethylene-vinyl acetate copolymers; ethylene-(meth)acrylate (co)polymers; melamine-based resins; urea-based resins; olefin-based resins; and the like. These may be used alone or in combination.

Among these, one or at least two copolymer materials selected from the group consisting of (co)polymers of (meth)acrylic ester, styrene-(meth)acrylic ester (co)polymers, polyether-based urethane resins, ethylene-vinyl acetate copolymers, ethylene-(meth)acrylate (co)polymers may be used.

Although the particle diameter of the cationic emulsion type adhesive is not particularly limited, it is generally within a range approximately from 5 to 1000 nm, preferably approximately 12 to 500 nm, and more preferably approximately 20 to 300 nm. When the particle diameter is extremely large, the printing density tends to decrease because the transparency decreases. When the particle diameter is extremely small, there is a case in which the ink-absorbability deteriorates.

Although the minimum film-forming temperature of the cationic emulsion type adhesive is not particularly limited, it is preferable that the minimum film-forming temperature be within a range approximately from 20 to 110° C., and more preferably approximately 30 to 100° C. When the minimum film-forming temperature is higher than 110° C., there is a case in which the coating film is weak, and thereby the surface strength of the ink jet recording material decreases. When the minimum film-forming temperature is lower than 20° C., there is a case in which the film-forming caused by the adhesive excessively proceeds, and thereby the ink-absorbability deteriorates.

The content of the cationic emulsion type adhesive, with respect to 100 parts by mass of the fine pigment, is preferably within a range from 1 to 50 parts by mass, and more preferably 5 to 30 parts by mass.

To the glossy layer, a polyvinyl alcohol, polyvinylpyrrolidone, copolymers thereof, cellulose derivatives such as hydroxyethyl cellulose, polysaccharides such as modified guar gums, modified starches, or the like, may be formulated, provided that effects exhibited by the cationic emulsion type adhesive are not impaired.

The glossy layer according to the present invention is formed by pressing, by a press roll, the layer of the coating liquid containing the cationic fine pigment and the cationic adhesive, the coating liquid being applied on the ink-receptive layer, while making the layer contact with the glossy roll which is heated. In order to control the removability from the glossy roll, a release agent is preferably used.

When the release agent is used, in addition to a process for formulating it to the coating liquid for the glossy layer, a process in which the release agent is formulated in the coating liquid for the ink-receptive layer, a process in which the release agent is applied on the glossy roll, or the like may be adopted. These processes can realize excellent removability from the metal surface, and may be adopted alone or in suitable combination. Among these processes, the process in which the release agent is formulated in the coating liquid for the glossy layer is particularly preferable because effects of the release agent can be exhibited using a small amount thereof.

As the release agent, various release agents generally used for producing cast-coated paper may be used, but a release agent represented by the following formula is preferably used:

R₁—N⁺R₂R₃R₄X⁻

(in the formula, R₁ represents an alkyl or alkenyl group having 10 to 18 carbon atoms, R₂, R₃, and R₄ each represents H or an alkyl group having 1 to 4 carbon atoms, and X⁻ represents F⁻, Cl⁻, Br⁻, or I⁻).

Specific examples thereof include stearyl ammonium chloride, stearyl trimethyl ammonium chloride, stearyl triethyl ammonium chloride, stearyl tributyl ammonium chloride, stearyl trimethyl bromide, stearyl trimethyl fluoride, stearyl trimethyl iodide, stearyl monomethyl ammonium chloride, stearyl dimethyl ammonium chloride, oleyl ammonium chloride, oleyl trimethyl ammonium chloride, oleyl triethyl ammonium chloride, oleyl tributyl ammonium chloride, oleyl trimethyl bromide, oleyl trimethyl fluoride, oleyl trimethyl iodide, oleyl monomethyl ammonium chloride, oleyl dimethyl ammonium chloride, lauryl ammonium chloride, lauryl trimethyl ammonium chloride, lauryl triethyl ammonium chloride, lauryl tributyl ammonium chloride, lauryl trimethyl bromide, lauryl trimethyl fluoride, lauryl trimethyl iodide, lauryl monomethyl ammonium chloride, lauryl dimethyl ammonium chloride, palmityl ammonium chloride, palmityl trimethyl ammonium chloride, palmityl triethyl ammonium chloride, palmityl tributyl ammonium chloride, palmityl trimethyl bromide, palmityl trimethyl fluoride, palmityl trimethyl iodide, palmityl monomethyl ammonium chloride, palmityl dimethyl ammonium chloride, myristyl ammonium chloride, myristyl trimethyl ammonium chloride, myristyl triethyl ammonium chloride, myristyl tributyl ammonium chloride, myristyl trimethyl bromide, myristyl trimethyl fluoride, myristyl trimethyl iodide, myristyl monomethyl ammonium chloride, myristyl dimethyl ammonium chloride, and the like.

In the glossy layer, a cationic compound may be formulated, as needed, so as to fix a dye contained in ink, impart water resistance, and improve recording density, in a similar way to that of the ink-receptive layer.

Examples of the cationic compound include polyalkylene polyamines such as polyethylene polyamine or polypropylene polyamine, and derivatives thereof, acrylic resins having a secondary or tertiary amino group, or quaternary ammonium group, polyvinylamines, polyvinylamidines, dicyan-based cationic resins exemplified by dicyandiamide-formalin polycondensation products, polyamine-based cationic resins exemplified by dicyandiamide-diethylene triamine polycondensation products, epichlorohydrin-dimethylamine addition polymers, diallyldimethyl ammonium chloride-sulfur dioxide copolymers, diallylamine salt-sulfur dioxide copolymers, copolymers of alkoxy-modified polyallylamine and polyallylamine or salts thereof, diallyldimethyl ammonium chloride polymers, polymers of allylamine salts, polymers of dialkylamine (meth)acrylate quaternary salts, cationic compounds such as copolymers of acrylamide-diallylamine salts, polymers of acrylonitrile and N-vinyl acrylamidine hydrochloride and hydrolysates thereof, polyamidine-based resins, aluminum polyoxychloride, aluminum acetate, zirconium chloride, and the like. These may be used alone or in combination.

In the glossy layer, a thio compound may be formulated as a preservability-improver, if needed. In particular, among the thio compounds, 1,2-bis(2-hydroxyethylthio) ethane, 1,2-bis(2-hydroxyethylthio)butane, 2,2′-dithioethanol, and 3,3′-thiodipropionic acid are preferable, and 1,2-bis(2-hydroxyethylthio) ethane is more preferable. These thio compounds may be used alone, or in combination of at least two kinds thereof.

The coating liquid for the glossy layer is prepared by dispersing these components in a suitable dispersion medium. Also, in addition to the above, various auxiliary agents generally used for producing coating paper, such as various pigments, dispersants, thickeners, antifoamers, coloring agents, antistatic agents, antiseptic agents, or the like, may be suitably formulated to the coating liquid for the glossy layer.

The glossy layer is formed extremely thinly on the ink-receptive layer so as to prevent deterioration of the ink-absorbability. The solid coating amount of the glossy layer is preferably within a range from 0.01 to 10 g/m², more preferably 0.1 to 5 g/m², and even more preferably 0.2 to 2 g/m². When the coating amount is extremely small, it is difficult to realize a desirable degree of the luster gloss. On the contrary, when the coating amount is extremely great, there is a possibility in which the ink-absorbability significantly deteriorates.

As a coating apparatus available for forming the glossy layer, various well-known coating apparatus such as a blade coater, air-knife coater, roll coater, bar coater, gravure coater, rod blade coater, lip coater, die coater, curtain coater, slide bead coater, or the like, may be used. Also, the coating liquid may be applied at a nip portion between a glossy roll and a press roll.

The glossy layer is formed by applying the coating liquid, and, while the coating liquid is in a wet state, applying the pressure to the rear surface of the assembly using a press roll while making a layer of the coating liquid contact with a heated glossy roll, followed by removing the resultant coating liquid layer from the glossy roll, and then drying. The glossy roll is not particularly limited in terms of the kind of materials or the like, and a roll with a specular surface coated with chrome (such as, for example, a casting drum) may be used.

The surface temperature of the glossy roll is preferably adjusted to a temperature within a range from 40 to 110° C., and more preferably 60 to 100° C., in terms of operationality such as drying conditions or the like, adhesiveness to the ink-receptive layer, and the glossiness of the glossy layer surface. When the surface temperature of the glossy roll is lower than 40° C., there is a possibility in which the surface strength of the ink jet recording material decreases and there is a case in which the adhesive in the ink-receptive layer is not easily softened, and the adhesiveness to the ink-receptive layer deteriorates. When the surface temperature exceeds 110° C., there is a possibility in which the film-forming caused by the adhesive of the ink-receptive layer proceeds extremely, and thereby the ink-absorbability deteriorates, or the coating liquid for the glossy layer boils to deteriorate the surface condition of the glossy layer.

In general, a cast-coated paper is exemplified as a glossy paper prepared using a glossy roll. As a process for producing the cast-coated paper, (1) a wet casting process in which a pigment composition mainly containing a pigment and an adhesive is applied on a base paper, and then, while the resultant coating layer is in a wet state, the coating layer is brought into contact and pressed to a heated glossy roll subjected to a specular surface finish (specular surface drum), and then dried so as to produce a luster finish; (2) a gelation casting process in which a coating layer in a wet state is gelated by applying an acid or salt, or heating, and the gelated coating layer is brought into contact and pressed to a heated glossy roll subjected to a specular surface finish (specular surface drum), and then dried so as to produce a luster finish; (3) a rewet casting process in which a coating liquid in a wet state is once dried, followed by wetting the dried coating layer again with a rewet liquid so as to be plasticized, bringing the coating layer into contact and pressing to a heated glossy roll subjected to a specular surface finish (specular surface drum), and then drying so as to produce a luster finish, and the like, have been known.

In these processes for producing the cast-coated paper, a coating liquid in a wet state is dried while contacting it to a glossy roll, and vapor converted from moisture contained in the coating liquid passes through to the rear side. However, when a low air-permeable or air-impermeable support is used according to the present invention, the vapor is not emitted, and so the vapor is retained between the support and the glossy roll. At that time, there is a case in which the vapor which has nowhere to escape during contacting with the glossy roll holds up the support, and destroys the weakest portion in the coating layer (such as a recording layer, glossy layer, or solvent-absorptive layer). When the coating layer is not sufficiently adhered to the heated glossy roll subjected to a specular surface finish, the coating layer is separated from the surface of the glossy roll, and thereby, the specular surface of the glossy roll is not sufficiently copied, and a so-called insufficient adherence phenomenon is caused. When the adherence of the inside of an undried coating layer is weaker than the adherence between the glossy roll and the coating layer, the inside of the coating layer is destroyed, and thereby a part of the coating layer remains on the surface of the glossy roll and the glossy roll becomes dirty.

In both cases, a satisfactory casting surface is not formed, and inconveniences in quality and operationality occur. Accordingly, it is quite difficult to obtain a cast-coated paper using a low air-permeable or air-impermeable support such as a resin-coated paper or film.

In a general process for producing a cast-coated paper, as described above, the surface of the coating layer in a wet state is pressed against a heated glossy roll, dried, and then removed from the glossy roll to copy the specular surface. On the other hand, since the support according to the present invention is a low air-permeable or air-impermeable support, it is preferable that the coating liquid be pressed and contacted to the specular surface drum immediately after applying it or during applying it (for example, nipping it), followed by drying it at a post-process using a drier.

That is, the surface of the coating layer for the glossy layer in a wet state is pressed using a press roll while making the surface contact with the heated glossy roll, to weld it with pressure and dry it, followed by removing it from the glossy roll to copy the specular surface thereto. It is not necessarily required that the coating liquid for the glossy layer, applied on the ink-receptive layer, be completely dried. It is also possible that drying be separately performed at a drying zone, and after the moisture in the coating liquid for the glossy layer transfers to the ink-receptive layer, the concentration of the cationized fine pigment in the coating liquid for the glossy layer is increased, and the cationized fine pigment is fixed on the surface of the ink-receptive layer.

The glossy roll is preferably a metal roll because a favorable heat-resistance and excellent specular surface can be realized. When a semiglossy paper is prepared by imparting a fine unevenness to the surface thereof so as to decrease the glossiness, a fine unevenness may be imparted to the surface of the metal roll. Although the average line center roughness Ra of the glossy roll depends on the degree of glossiness aimed at, the average line center roughness is 10 μm or less, for example.

Although the kinds of materials of the press roll are not particularly limited, a roll prepared using a heat-resistant resin is preferably used so as to realize uniform pressurization between the press roll and the glossy roll as described above.

The pressurization using the press roll be preferably performed so that the linear pressure between the glossy roll and the press roll is within a range from 50 to 3500 N/cm, and more preferably 200 to 3000 N/cm. When the linear pressure between the glossy roll and the press roll is less than 50 N/cm, it is difficult to realize uniform linear pressure, and there is a possibility in which the luster gloss deteriorates, the adhesiveness of a coating liquid 7 for the glossy layer to an ink-receptive layer 3 decreases, and the surface is cracked. When the linear pressure between the glossy roll and the press roll is more than 3500 N/cm, there is a possibility in which the ink jet recording material is excessively pressurized, and thereby, airspaces in the ink-receptive layer and the glossy layer are lost, as a result of which the ink-absorbability deteriorates.

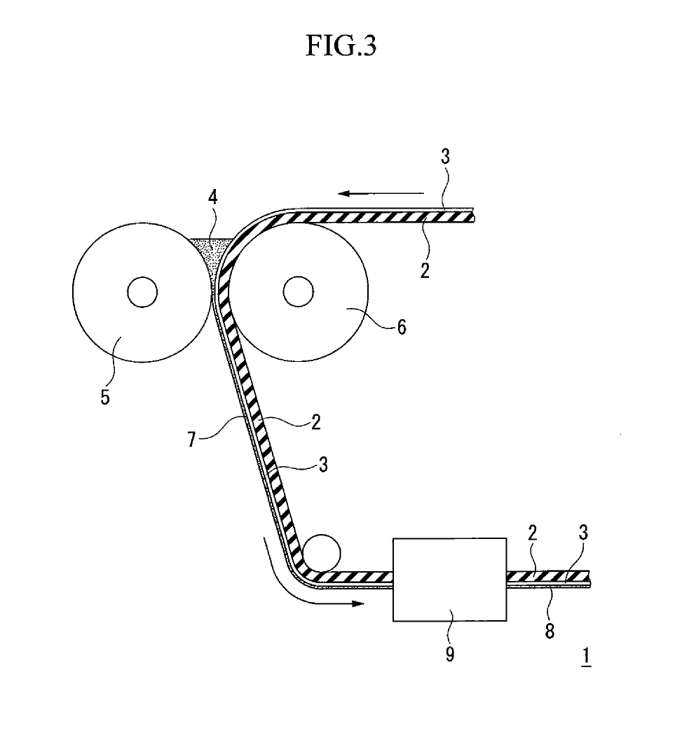

Next, an aspect of a process for forming a preferable glossy layer according to the present invention using a manufacturing device as shown in FIG. 3 will be explained. First, an ink-receptive layer 3 is formed as a single layer or plural layers directly on a support 2, or on a solvent-absorptive layer (not shown in the drawing) formed on the support 2. Then, the support 2 is placed between a glossy roll 5 and a press roll 6 so that the ink-receptive layer 3 contacts with the glossy roll 5. Then, a coating liquid 4 for a glossy layer is supplied on the ink-receptive layer 3 so that a coating liquid pool for the glossy layer is formed over tangential lines of the glossy roll 5 and the press roll 6 (step of supplying coating liquid for glossy layer).

Then, while the supplied coating liquid 4 for the glossy layer is in a wet state or semiwet state, the support 2 is passed between the glossy roll 5 and the press roll 6 while applying pressure and making the surface on which the coating liquid 4 for the glossy layer is supplied contact with the glossy roll 5, to form a coating liquid layer 7 for the glossy layer. Immediately after that, the coating liquid layer 7 for the glossy layer is separated from the glossy roll 5 (step of pressing).

Then, drying (humidity conditioning) is performed using a drier 9 to obtain an ink jet recording sheet 1 composed of the support 2, the ink-receptive layer 3, and the glossy layer 8 (step of drying (humidity conditioning)).

In the following, each of the step of supplying coating liquid for glossy layer, step of pressing, and step of drying (humidity conditioning) will be explained in more detail.

### (Step of Supplying Coating Liquid for Glossy Layer)

The glossy layer is formed by applying on the support a coating liquid in which the fine pigment and other components as described above are dispersed in a solvent, and then drying the coating liquid. Although the solvent contained in the coating liquid is not particularly limited, water is preferable in terms of coating suitability.

### (Step of Pressing)

In the step of pressing, while the supplied coating liquid 4 for the glossy layer is in a wet state or semiwet state, the support 2 is passed between the glossy roll 5 and the press roll 6, while applying pressure therebetween, and while contacting the surface, on which the coating liquid 4 for the glossy layer is supplied, to the glossy roll 5, so as to form the coating liquid layer 7 for the glossy layer. Immediately after forming the coating liquid layer 7, the coating liquid layer 7 is removed from the glossy roll 5.

By pressing the coating liquid 4 for the glossy layer in a wet state or semiwet state by a press roll 6 between the heated glossy roll 5 and the press roll 6, so that the surface, on which the coating liquid 4 is supplied, contacts with the glossy roll 5, the coating liquid layer 7 for the glossy layer is formed on the ink-receptive layer 3. At the time, the coating liquid layer 7 for the glossy layer is adhered to the ink-receptive layer 3 by applied pressure and temperature, as a result of which a uniform film free from cracking is formed.

After the step of pressing, the step of drying (humidity conditioning), in which the coating liquid layer 7 for the glossy layer is separately dried at a drying zone using the drier 9 or the like, may be performed.

It is preferable that the surface temperature of the glossy roll be within a range from 40 to 110° C., and more preferably 60 to 100° C., in view of operationality such as drying conditions or the like, adhesiveness to the ink-receptive layer, glossiness of the glossy layer. When the surface temperature of the glossy roll is lower than 40° C., there is a possibility in which the surface strength of the ink jet recording material decreases, the adhesive contained in the ink-receptive layer is not easily softened, or the adhesiveness to the ink-receptive layer deteriorates. When the surface temperature exceeds 110° C., there is a possibility in which the film-forming caused by the adhesive in the ink-receptive layer excessively proceeds, and so the ink-absorbability deteriorates, or the coating liquid 4 for the glossy layer is boiled, and so the surface condition of the glossy layer deteriorates.

It is preferable that the glossy roll be a metal roll, because favorable heat resistance and an excellent specular surface can be realized. When a so-called semigloss paper, of which the surface is finely uneven, is prepared, a metal roll of which the surface is finely uneven may be used. Although the average line center roughness Ra of the glossy roll depends on the degree of luster gloss aimed at, the average line center roughness Ra is 10 μm or less, for example.

It is preferable that the press roll be prepared using a heat-resistant resin so as to realize further uniform pressurization between it and the glossy roll.

The pressurization by the press roll is preferably performed while maintaining the linear pressure between the glossy roll and the press roll within a range from 50 to 3500 N/cm, and more preferably 200 to 3000 N/cm. When the linear pressure between the glossy roll and the press roll is lower than 50 N/cm, there is a possibility in which the uniform linear pressure is not easily realized, and the thereby luster gloss deteriorates, or the adhesiveness of the coating liquid layer 7 for the glossy layer to the ink-receptive layer 3 deteriorates, and thereby the surface is cracked. When the linear pressure exceeds 3500 N/cm, there is a possibility in which the ink jet recording material is excessively pressed, airspaces in the ink-receptive layer and the glossy layer are destroyed, and thereby the ink-absorbability deteriorates.

### (Step of Drying (Humidity Conditioning))

According to the present invention, the moisture of the ink jet recording material 1 (the support 2, ink-receptive layer 3, and coating liquid layer 7 for the glossy layer) freshly-removed from the glossy roll 5 remains in a wet state or semiwet state. Although the moisture content of the coating layer largely depends on the coating amount of the ink-receptive layer and the glossy layer, the moisture content is 7 to 100%, for example.

Although no humidity controller and drier is required when the moisture content reaches an equilibrium moisture before rolling up, with a winder, the ink jet recording material removed from the glossy roll 5, a humidity conditioning step using a humidity controller or a drying step using a drier is required until the ink jet recording material removed from the glossy roll 5 is rolled up with a winder, when the coating speed is rapid and the moisture content in the support 2 such as paper is high. The ability or the specification of the humidity conditioning or the drier is suitably determined in accordance with the difference between the moisture content of the ink jet recording material at the time of being separated from the glossy roll 5 and the equilibrium moisture thereof, and coating speed.

Although the support is passed in a longitudinal direction through the coating liquid pool for the glossy layer formed over the tangential lines of the glossy roll 5 and the press roll 6, the glossy roll 5 and the press roll 6 being horizontally arranged, in FIG. 3, the support may be passed in a lateral direction between the glossy roll 5 and the press roll 6 while supplying the coating liquid 4 onto the ink-receptive layer 3, the glossy roll 5 and the press roll 6 being vertically arranged, for example.

As described above, according to the conventional process for producing a cast-coated paper, the surface of a coating layer in a wet and plasticized state is pressed to contact with a heated glossy roll and then dried to form a glossy layer, followed by separating the glossy layer from the glossy roll to copy the specular surface. On the other hand, according to the present aspect, a coating liquid for the glossy layer, containing a fine pigment and a specific release agent, is supplied on the ink-receptive layer, and then, while the coating liquid is in a wet state or semiwet state, the support is passed between the glossy roll and the press roll while applying pressure and keeping the surface, on which the coating liquid is supplied, contacting with the glossy roll to form a coating liquid layer for the glossy layer, followed by immediately removing the coating liquid layer for the glossy layer from the glossy roll to form the glossy layer.

It is preferable that the surface of the glossy layer have a 75-degree specular glossiness (JIS P 8142) of 70% or larger, more preferably 75% or larger, and even more preferably 80% or larger, together with an image clarity (JIS H 8686-2), in which an optical comb with a width of 2.0 mm is used, of 55% or higher, more preferably 57% or higher, even more preferably 60% or higher, and particularly even more preferably 65% or higher, so as to realize a texture equivalent to that of silver halide photography.

The ink jet recording material obtained by such a way has a white paper glossiness and surface quality equivalent to those of silver halide photography, and realizes an ink jet recordability excellent in scratch resistance at a blank paper part and pigment-ink fixing-properties.

When the cut edge type resin-coated paper 10 in which end edges 11a and 12a in a width direction of the paper base material 11 and the resin layers 12, 12 are lined up on the same plane is used as the support 2, since the resin layers 12 do not protrude from the paper base material 11 in the resin-coated paper 10, end portions in a width direction of the resin layers 12 are not easily adhered to the glossy roll 5, occurrence of soiling on the surface of the glossy roll 5 can be prevented, uniform drying at end portions can be performed, and excellent continuous operationality can be realized.

### EXAMPLES

In the following, the present invention will be explained in more detail by illustrating the following examples. However, it is apparent that the scope of this present invention is not limited to these. Also, “parts” and “%” used in the examples indicate “parts by mass” and “% by mass” unless otherwise so indicated.

### Preparation of Silica Dispersion Liquid

### (Cationized Silica Dispersion Liquid A)

100 parts of silica prepared by a precipitation method (manufactured by TOKUYAMA Corp., under the trademark of FINESEAL X-45 with an average primary particle diameter of 10 nm and an average secondary particle diameter of 4.5 μm) was dispersed in 1249 parts of ion-exchanged water using a stirrer, followed by repeatedly performing pulverization and dispersing using a wet-type ultra-fine pulverizer (manufactured by NANOMIZER, INC., under the trademark of NANOMIZER) to obtain a dispersion liquid with an average secondary particle diameter of 80 nm. To the dispersion liquid, 26 parts of an aqueous solution containing 39% of diallyldimethyl ammonium chloride (manufactured by SENKA CORPORATION under the trade name of UNISENCE CP-103) was added to cause agglomeration of pigment and viscosity-increase of the dispersion liquid, followed by repeatedly performing pulverization and dispersion again using a wet-type ultra-fine pulverizer, NANOMIZER, to obtain a cationized silica dispersion liquid A in which the concentration of the cationized silica was 8% and the average secondary particle diameter thereof was 250 nm.

### (Cationized Silica Dispersion Liquid B)

100 parts of fumed silica (manufactured by NIPPON AEROSIL CO., LTD., under the trademark of AEROSIL 380, with an average primary particle diameter of 7 nm and a specific surface area, by BET method, of 380 m²/g) was dispersed in a composition composed of 849 parts of ion-exchanged water, and 51 parts of an aqueous solution containing 25% of poly(diallyldimethyl ammonium chloride-acrylicamide) using a stirrer, followed by repeatedly performing pulverization and dispersing using a wet-type ultra-fine pulverizer, NANOMIZER (manufactured by NANOMIZER, INC., under the trademark of NANOMIZER) to obtain a cationized silica dispersion liquid B in which the concentration of the cationized silica was 12% and the average secondary particle diameter thereof was 400 nm).

### Preparation of Adhesive Dispersion Liquid

### (Cationic Adhesive Dispersion Liquid A)

187.7 parts of ion-exchanged water and 10 parts of an aqueous solution containing 10% of stearyl trimethyl ammonium chloride were put into a reactor, and the temperature thereof was raised to 70° C. under a nitrogen gas stream, followed by adding 60 parts of an aqueous solution containing 1% of 2,2′-azobis(2-amidinopropane) dihydrochloride to the reactor. Aside from the above, 75 parts of methyl methacrylate and 25 parts of n-butyl acrylate were emulsified in a composition composed of 37.3 parts of ion-exchanged water and 3 parts of an aqueous solution containing 10% of stearyl trimethyl ammonium chloride to obtain an emulsified mixture. The emulsified mixture was added dropwise to the reactor over 4 hours, and then the reactor was maintained at 70° C. for 4 hours. Moreover, 10 parts of an aqueous solution containing 1% of 2,2′-azobis(2-amidinopropane) dihydrochloride was further added to the reactor, and then the reactor was maintained at 70° C. for 3 hours to complete polymerization. Thus, a cationic adhesive dispersion liquid A in which the concentration of the cationic adhesive was 25%, pH was 5, the particle diameter thereof was 54 μm, and the minimum film-forming temperature thereof was 45° C., was obtained.

### (Cationic Adhesive Dispersion Liquid B)

187.7 parts of ion-exchanged water and 10 parts of an aqueous solution containing 10% stearyl trimethyl ammonium chloride were put into a reactor, and the temperature of the reactor was raised to 70° C. under a nitrogen gas stream, followed by adding 60 parts of an aqueous solution containing 1% of 2,2′-azobis(2-amidinopropane) dihydrochloride to the reactor. Aside from the above, 90 parts of methyl methacrylate and 10 parts of n-butyl acrylate were emulsified in a composition composed of 37.3 parts of ion-exchanged water and 3 parts of an aqueous solution containing 10% of stearyl trimethyl ammonium chloride to prepare an emulsified mixture. The emulsified mixture was added dropwise to the reactor over 4 hours, and then the reactor was held at 70° C. for 4 hours. Moreover, 10 parts of an aqueous solution containing 1% of 2,2′-azobis(2-amidinopropane) dihydrochloride was further added to the reactor, and then the reactor was held at 70° C. for 3 hours to complete polymerization. Thus, a cationic adhesive dispersion liquid B in which the concentration of the cationic adhesive was 25%, pH was 5, the particle diameter thereof was 50 nm, and the minimum film-forming temperature thereof was 85° C., was obtained

### (Cationic Adhesive Dispersion Liquid C)

187.7 parts of ion-exchanged water and 10 parts of an aqueous solution containing 10% of stearyl trimethyl ammonium chloride were put into a reactor, and the temperature thereof was raised to 70° C. under a nitrogen gas stream, followed by adding 60 parts of an aqueous solution containing 1% of 2,2′-azobis(2-amidinopropane) dihydrochloride to the reactor. Aside from the above, 99 parts of methyl methacrylate and 1 part of n-butyl acrylate were emulsified in a composition composed of 37.3 parts of ion-exchanged water and 3 parts of an aqueous solution containing 10% of stearyl trimethyl ammonium chloride to prepare an emulsified mixture. The emulsified mixture was added dropwise to the reactor over 4 hours, and then the reactor was held at 70° C. for 4 hours. Moreover, 10 parts of an aqueous solution containing 1% of 2,2′-azobis(2-amidinopropane) dihydrochloride was further added to the reactor, and then the reactor was held at 70° C. for 3 hours to complete polymerization. Thus, a cationic adhesive dispersion liquid C in which the concentration of the cationic adhesive was 25%, pH was 5, the particle diameter thereof was 50 nm, and the minimum film-forming temperature thereof was 107° C., was obtained.

### (Cationic Adhesive Dispersion Liquid D)

187.7 parts of ion-exchanged water and 10 parts of an aqueous solution containing 10% of stearyl trimethyl ammonium chloride were put into a reactor, and the temperature thereof was raised to 70° C. under a nitrogen gas stream, followed by adding 60 parts of an aqueous solution containing 1% of 2,2′-azobis(2-amidinopropane) dihydrochloride to the reactor. Aside from the above, 60 parts of methyl methacrylate and 40 parts of n-butyl acrylate were emulsified in a composition composed of 37.3 parts of ion-exchanged water and 3 parts of an aqueous solution containing 10% of stearyl trimethyl ammonium chloride to prepare an emulsified mixture. The emulsified mixture was added dropwise to the reactor over 4 hours, and then the reactor was held at 70° C. for 4 hours. Moreover, 10 parts of an aqueous solution containing 1% of 2,2′-azobis(2-amidinopropane) dihydrochloride was further added to the reactor, and then the reactor was held at 70° C. for 3 hours to complete polymerization. Thus, a cationic adhesive dispersion liquid D in which the concentration of the cationic adhesive was 25%, pH was 5, the particle diameter thereof was 48 nm, and the minimum film-forming temperature thereof was 10° C., was obtained.

### (Anionic Adhesive Dispersion Liquid A)

197.3 parts of ion-exchanged water and 10 parts of an aqueous solution containing 10% of sodium dodecylbenzenesulfonate were put into a reactor, and then the temperature thereof was raised to 70° C. under a nitrogen gas stream, followed by adding 60 parts of an aqueous solution containing 1% of potassium peroxodisulfate to the reactor. Aside from the above, 90 parts of methyl methacrylate and 10 parts of n-butyl acrylate were emulsified in a composition composed of 37.3 parts of ion-exchanged water and 3 parts of an aqueous solution containing 10% of sodium dodecylbenzenesulfonate to prepare an emulsified mixture. The emulsified mixture was added dropwise to the reactor over 4 hours, and then the reactor was held at 70° C. for 4 hours to complete polymerization. Thus, an anionic adhesive dispersion liquid A in which the concentration of the anionic adhesive was 25%, pH was 2, the particle diameter thereof was 48 nm, and the minimum film-forming temperature thereof was 85° C., was obtained.

### Preparation of Each Coating Liquid

### (Preparation of Coating Liquid for Solvent-Absorptive Layer)

109 parts of silica prepared by a gel method (manufactured by Grace-Debison Co., Ltd., under the trademark of SILOJET P612 with an average primary particle diameter of 10 nm and an average secondary particle diameter of 7.5 μm), 523 parts of an aqueous solution containing 5% of silyl modified polyvinyl alcohol (manufactured by KURARAY CO., LTD., under the trademark of KURARAY POVAL PVA R-1130), and 269 parts of water were mixed and stirred to obtain a coating liquid A for an ink-receptive layer.

### (Preparation of Coating Liquid for Ink-Receptive Layer)

105 parts of the cationized silica dispersion liquid A, 503 parts of an aqueous solution containing 5% of polyvinyl alcohol (manufactured by KURARAY CO., LTD., under the trademark of KURARAY POVAL PVA-135H), and 1017 parts of water were mixed and stirred to obtain a coating liquid B for an ink-receptive layer.

### Preparation of Support

### (Support A)

A needle-leaved tree bleached kraft pulp (NBKP) beaten to 250 ml CSF (JIS P 8121) and a broad-leaved tree bleached kraft pulp (LBKP) beaten to 250 ml CSF were mixed in amass ratio of 2:8 to prepare a 0.5% pulp slurry. To the pulp slurry, 2.0% of cationized starch, 0.4% of alkyl ketene dimer, 0.1% of anionized polyacrylamide resin, and 0.7% of polyamide polyamine epichlorohydrin resin, with respect to the total dry mass of the pulp, were added, and sufficiently stirred to disperse them.

The thus prepared pulp slurry was made into paper using a Fourdrinier machine, passed through a drier, size-presser, and machine calendar to obtain a base paper with a basis weight of 180 g/m² and a density of 1.0 g/cm³. The size-pressing liquid used in the size-pressing step was a 5% solution prepared by mixing a carboxyl-modified polyvinyl alcohol and sodium chloride in a mass ratio of 2:1, followed by adding water to the mixture, and then heating to dissolve them. This size-pressing liquid was applied on both surfaces of the paper in the total amount of 25 ml/m² to obtain a support A.

### (Support B)

Both surfaces of the support A were subjected to a corona discharge treatment, and then the felt side of the support A was coated with a polyolefin resin composition A mixed and dispersed using a Banbury mixer, as described below, in a coating amount of 25 g/m². The wire side of the support A was coated with a polyolefin resin composition B in a coating amount of 20 g/m² using a melt extruder equipped with a T-die (melting temperature: 320° C.). Then, the felt side was cooled and fixed using a cooling roll with a specular surface, and the wire side was cooled and fixed using a cooling roll with a rough surface. Thus, a support B coated with resin, of which the smoothness (Ohken-type, J. TAPPI No. 5) was 6000 seconds and the opacity (JIS P 8138) was 93%, was obtained.

### “Polyolefin Resin Composition A”

35 parts of a long-chain low-density polyethylene resin (with a density of 0.926 g/cm³ and a melt index of 20 g/10 minutes), 50 parts of a low-density polyethylene resin (with a density of 0.919 g/cm³ and a melt index of 2 g/10 minutes), 15 parts of anatase-type titanium dioxide (manufactured by ISHIHARA SANGYO KAISHA, LTD., under the trade name of A-220), 0.1 parts of zinc stearate, 0.03 parts of antioxidant (manufactured by Ciba-Geigy K.K., under the trademark of IRGANOX 1010), 0.09 parts of ultramarine blue (manufactured by DAIICHI KASEI CO., LTD., under the trade name of blue ultramarine blue No. 2000), and 0.3 parts of a fluorescent brightener (manufactured by Ciba-Geigy K.K., under the trademark of UVITEX OB) were mixed to prepare a polyolefin resin composition A.

### “Polyolefin Resin Composition B”

65 parts of a high-density polyethylene resin (with a density of 0.954 g/cm³ and a melt index of 20 g/10 minutes) and 35 parts of low-density polyethylene resin (with a density of 0.919 g/cm³ and a melt index of 2 g/10 minutes) were melted and mixed to prepare a polyolefin resin composition B.

### (Support C)

A polypropylene synthesized paper (manufactured by Yupo Corporation under the trademark of YUPO GWG-140) was used.

### (Support D)

The above-mentioned support B was cut in a longitudinal direction at portions 30 mm inward from end edges of resin layers using a slitter to prepare a support D, which is a resin-coated paper in which end edges in a width direction of the paper base material and resin layers thereof are lined up on the same plane.

### Example 1

On the support B, the coating liquid for the ink-receptive layer was applied in a dry coating amount of 27 g/m² using a die coater. The thickness of the ink-receptive layer was 44 μm.

Next, a coating liquid A for a glossy layer, as described above, was applied, and then immediately, while the coating liquid layer for the glossy layer was in a wet state, the coating liquid layer was pressed against and contacted to the specular surface of a drum coated with chrome, the temperature of the specular surface being adjusted to 90° C., at a linear pressure of 2000 N/cm. After thus forming the glossy layer, the glossy layer was dried using a drier to obtain an ink jet recording material. The coating amount of the glossy layer was 0.5 g/m².

### (Preparation of Coating Liquid a for Glossy Layer)

21.7 parts of cationized colloidal silica (manufactured by NISSAN CHEMICAL INDUSTRIES, LTD., under the trademark of SNOWTEX AK-L). 36.2 parts of the cationized silica dispersion liquid B, 3.5 parts of the cationic adhesive dispersion liquid A (with a particle diameter of 54 nm and a minimum film-forming temperature of 45° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 29.9 parts of water were mixed and stirred to prepare a coating liquid A for the glossy layer.

### Example 2

An ink jet recording material was prepared in a similar way to that of Example 1, except that a coating liquid B for the glossy layer was used instead of the coating liquid A for the glossy layer.

### (Preparation of Coating Liquid B for Glossy Layer)

21.7 parts of a fumed alumina (manufactured by Cabot Corporation., under the trade name of PG003), 3.5 parts of the cationic adhesive dispersion liquid A (with a particle diameter of 54 nm and a minimum film-forming temperature of 45° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare a coating liquid B for the glossy layer.

### Example 3

On the support B, the coating liquid for the solvent-absorptive layer was applied in a dry coating amount of 20 g/m² using a die coater. Before drying the coating liquid for the solvent-absorptive layer, the coating liquid for the ink-receptive layer was applied in a dry coating amount of 7 g/m² using a die coater, and then dried. The total thickness of the solvent-absorptive layer and the ink-receptive layer was 41 μm.

Then, the coating liquid A for the glossy layer (used also in Example 1) was applied, and then immediately, while the coating liquid layer for the glossy layer was in a wet state, the coating liquid layer was pressed against and contacted to the specular surface of a drum coated with chrome, the temperature of the specular surface being adjusted to 95° C., at a linear pressure of 2000 N/cm. After thus forming a glossy layer, the glossy layer was dried using a drier to obtain an ink jet recording material. The coating amount of the glossy layer was 0.5 g/m².

### Example 4

An ink jet recording material was prepared in a similar way to that of Example 3, except that the coating liquid B for the glossy layer (used also in Example 2) was used instead of the coating liquid A for the glossy layer.

### Example 5

An ink jet recording material was prepared in a similar way to that of Example 3, except that a coating liquid C for the glossy layer was used instead of the coating liquid A for the glossy layer.

### (Preparation of Coating Liquid C for Glossy Layer)

21.7 parts of a fumed alumina (manufactured by Cabot Corporation., under the trade name of PG003), 3.5 parts of the cationic adhesive dispersion liquid B (with a particle diameter of 50 nm and a minimum film-forming temperature of 85° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare the coating liquid C for the glossy layer.

### Example 6

An ink jet recording material was prepared in a similar way to that of Example 3, except that a coating liquid D for the glossy layer was used instead of the coating liquid A for the glossy layer.

### (Preparation of Coating Liquid D for Glossy Layer)

21.7 parts of a fumed alumina (manufactured by Cabot Corporation., under the trade name of PG003), 3.5 parts of the cationic adhesive dispersion liquid C (with a particle diameter of 48 nm and a minimum film-forming temperature of 107° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare the coating liquid D for the glossy layer.

### Example 7

An ink jet recording material was prepared in a similar way to that of Example 3, except that a coating liquid E for the glossy layer was used instead of the coating liquid A for the glossy layer.

### (Preparation of Coating Liquid E for Glossy Layer)

21.7 parts of a fumed alumina (manufactured by Cabot Corporation., under the trade name of PG003), 3.5 parts of a polyether-based cationic polyurethane resin (manufactured by DAI-ICHI KOGYO SEIYAKU CO., LTD., under the trademark of SUPERFLEX 600, with a particle diameter of 10 nm and a minimum film-forming temperature of approximately 84° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare the coating liquid E for the glossy layer.

### Example 8

An ink jet recording material was prepared in a similar way to that of Example 3, except that a coating liquid F for the glossy layer was used instead of the coating liquid A for the glossy layer.

### (Preparation of Coating Liquid F for Glossy Layer)

21.7 parts of a fumed alumina (manufactured by Cabot Corporation., under the trade name of PG003), 2.9 parts of polyester-based cationic polyurethane resin (manufactured by DAI-ICHI KOGYO SEIYAKU CO., LTD., under the trademark of SUPERFLEX 620, with a particle diameter of 30 nm and a minimum film-forming temperature of 30° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.7 parts of water were mixed and stirred to prepare the coating liquid F for the glossy layer.

### Example 9

An ink jet recording material was prepared in a similar way to that of Example 3, except that a coating liquid G for the glossy layer was used instead of the coating liquid A for the glossy layer.

### (Preparation of Coating Liquid G for Glossy Layer)

21.7 parts of a fumed alumina (manufactured by Cabot Corporation., under the trade name of P003), 1.9 parts of a cationic ethylene methacrylate copolymer (manufactured by Chuo Rika Kogyo Corporation, under the trademark of AQUATEX AC-3100, with a particle diameter of 700 nm and a minimum film-forming temperature of 90° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 67.7 parts of water was mixed and stirred to prepare the coating liquid G for the glossy layer.

### Example 10

An ink jet recording material was prepared in a similar way to that of Example 3, except that a coating liquid H for the glossy layer was used instead of the coating liquid A for the glossy layer.

### (Preparation of Coating Liquid H for Glossy Layer)

21.7 parts of a fumed alumina (manufactured by Cabot Corporation., under the trade name of PG003), 2.2 parts of a cationic ethylene-vinyl acetate copolymer (manufactured by Chuo Rika Kogyo Corporation, under the trademark of AQUATEX MC-3800, with a particle diameter of 900 nm and a minimum film-forming temperature of 80° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 67.4 parts of water were mixed and stirred to prepare the coating liquid H for the glossy layer.

### Example 11

An ink jet recording material was prepared in a similar way to that of Example 2, except that the support C was used instead of the support B.

### Example 12

An ink jet recording material was prepared in a similar way to that of Example 4, except that the support C was used instead of the support B.

### Example 13

An ink jet recording material was prepared in a similar way to that of Example 3, except that a coating liquid I for the glossy layer was used instead of the coating liquid A for the glossy layer.

### (Preparation of Coating Liquid I for Glossy Layer)

21.7 parts of a fumed alumina (manufactured by Cabot Corporation., under the trade name of PG003), 3.5 parts of the cationic adhesive dispersion liquid D (with a particle diameter of 56 nm and a minimum film-forming temperature of 10° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare the coating liquid I for the glossy layer.

### Example 14

An ink jet recording material was prepared in a similar way to that of Example 1, except that the support D was used instead of the support B.

### Comparative Example 1

An ink jet recording material was prepared in a similar way to that of Example 2, except that the support A was used instead of the support B.

### Comparative Example 2

An ink jet recording material was prepared in a similar way to that of Example 4, except that the support A was used instead of the support B.

### Comparative Example 3

Although it was attempted to prepare an ink jet recording material in a similar way to that of Example 3, except that a coating liquid K for a glossy layer, described below, was used instead of the coating liquid A for the glossy layer, agglomeration was produced, and thereby the glossy layer could not be formed.

### (Preparation of Coating Liquid K for Glossy Layer)

Although 21.7 parts of a fumed alumina (manufactured by Cabot Corporation., under the trade name of PG003), 3.5 parts of an anionic adhesive dispersion liquid A (with a particle diameter of 48 nm and a minimum film-forming temperature of 85° C.), 4.4 parts of stearyl trimethyl ammonium chloride, 4.4 parts of an ethylene oxide adduct of acetylene glycol (manufactured by Nissin Chemical Industry Co., Ltd., under the trademark of OLFINE E1004), and 66.1 parts of water were mixed and stirred to prepare the coating liquid K for the glossy layer, agglomeration was produced.

### Comparative Example 4

An ink jet recording material was prepared in a similar way to that of Example 3, except that a coating liquid L for a glossy layer was used instead of the coating liquid A for the glossy layer.

### (Preparation of Coating Liquid L for Glossy Layer)

43.5 parts of an anionic colloidal silica (manufactured by NISSAN CHEMICAL INDUSTRIES, LTD., under the trademark of SNOWTEX OL), 3.5 parts of the anionic adhesive dispersion liquid A (with a particle diameter of 48 nm and a minimum film-forming temperature of 85° C.), 2.2 parts of a fatty acid derivative (manufactured by NISSIN KAGAKU KENKYUSHO CO., LTD., under the trade name of DEF-002), 4.4 parts of an ethylene oxide adduct of acetylene glycol (manufactured by Nissin Chemical Industry Co., Ltd., under the trademark of OLFINE E1004), and 46.5 parts of water were mixed and stirred to prepare the coating liquid L for the glossy layer.

### Comparative Example 5

An ink jet recording material was prepared in a similar way to that of Example 3, except that a coating liquid M for a glossy layer was used instead of the coating liquid A for the glossy layer.

### (Preparation of Coating Liquid M for Glossy Layer)

43.5 parts of an anionic colloidal silica (manufactured by NISSAN CHEMICAL INDUSTRIES, LTD., under the trademark of SNOWTEX OL), 2.5 parts of polyether-based anionic polyurethane resin (manufactured by DAI-ICHI KOGYO SEIYAKU CO., LTD., under the trademark of SUPERFLEX 130, with a particle diameter of 20 nm and a minimum film-forming temperature of approximately 55° C.), 2.2 parts of a fatty acid derivative (manufactured by NISSIN KAGAKU KENKYUSHO CO., LTD., under the trade name of DEF-002), 4.4 parts of an ethylene oxide adduct of acetylene glycol (manufactured by Nissin Chemical Industry Co., Ltd., under the trademark of OLFINE E1004), and 47.5 parts of water were mixed and stirred to prepare the coating liquid M for the glossy layer.

### Comparative Example 6

An ink jet recording material was prepared in a similar way to that of Example 3, except that a coating liquid N for a glossy layer was used instead of the coating liquid A for the glossy layer.

### (Preparation of Coating Liquid N for Glossy Layer)

43.5 parts of an anionic colloidal silica (manufactured by NISSAN CHEMICAL INDUSTRIES, LTD., under the trademark of SNOWTEX OL), 1.8 parts of an anionic ethylene-vinyl acetate copolymer (manufactured by Chuo Rika Kogyo Corporation, under the trademark of AQUATEX EA-2800, with a particle diameter of 1200 nm and a minimum film-forming temperature of 65° C.), 2.2 parts of a fatty acid derivative (manufactured by NISSIN KAGAKU KENKYUSHO CO., LTD., under the trade name of DEF-002), 4.4 parts of an ethylene oxide adduct of acetylene glycol (manufactured by Nissin Chemical Industry Co., Ltd., under the trademark of OLFINE E1004), and 48.2 parts of water were mixed and stirred to prepare the coating liquid for the glossy layer.

### (Evaluation Method)

The coating liquids used for preparing the ink jet recording materials in Examples 1 to 13 and Comparative Examples 1 to 6 were evaluated in terms of the stability thereof, and the results thereof are shown in Table 1. Also, the ink jet recording materials prepared in Examples 1 to 13 and Comparative Examples 1 to 6 were evaluated in terms of 75-degree specular glossiness, image clarity, cockling, ink-absorbability, printing density, and suitability for pigment ink, and results thereof are shown in Table 1. Each evaluation was performed in accordance with the following methods.

### (Stability of Coating Liquid)

The stability of each coating liquid for the glossy layer was sensorily evaluated.

◯: There was no problems.

X: The coating liquid agglomerated, and could not be used for coating.

(75-degree specular glossiness)

The 75-degree specular glossiness of each ink jet recording material was evaluated in accordance with a method defined in JIS P 8142. When evaluation could not be performed because no ink jet recording material was prepared, “-” is indicated in the table.

### (Image Clarity)

Inage clarity at a blank paper part was measured by making light reflected at 45-degrees pass through an optical comb of 2.0 mm width while keeping the coating direction vertical with respect to the slit using an image clarity measuring apparatus (manufactured by SUGA TEST INSTRUMENTS Co., Ltd., under the trade name of ICM-1DP) in accordance with a method defined in JIS H 8686-2. Evaluation was repeated 5 times and an average thereof is shown in the table. When evaluation could not be performed because no ink jet recording material was prepared, “-” is indicated in the table.

### (Cockling)

The cockling was evaluated using an ink jet printer BJ-F870 (manufactured by Canon Inc.). As ink cartridges, BCI-6C, BCI-6M, BCI-6Y, BCI-BK, BCI-6PC photo, and BCI-6PM photo, manufactured by Canon Inc., were used. Evaluation was performed by visually observing cockling generated at a solid portion printed using a mixture composed of two colors, that is, a cyan ink and a magenta ink.

◯: No cockling was recognized, and condition was favorable.

Δ: Cockling was recognized, and condition was controversial depending on status of use.

X: Cockling was significantly recognized, and condition was not practical.

-: Evaluation could not be performed because no ink jet recording material was formed.

### (Ink-Absorbability)

The ink-absorbability was evaluated using an ink jet printer PIXUS 850i (manufactured by Canon Inc.). As ink cartridges, BCI-3eY, BCI-3eM, BCI-3eC, and BCI-3eBK, manufactured by Canon Inc., were used to perform solid printing of green. Then, evaluation was performed by visually observing the formed solid print portion.

⊚: The solid print portion was even and in a favorable condition.

◯: The solid print portion was slightly uneven, but in an uncontroversial condition from a practical standpoint.

Δ: The solid portion was somewhat uneven, and in a controversial condition depending on status of use.

-: Evaluation could not be performed because no ink jet recording material was formed.

### (Printing Density)

The printing density was evaluated using an ink jet printer PM-970C (manufactured by Seiko Epson Corporation). As ink cartridges, ICY21, ICM21, ICC21, ICLM21, ICLC21, ICDY21, and ICBK21, manufactured by Seiko Epson Corporation, were used. Evaluation was performed by measuring the reflection density of a solid print portion of black using a Gretagmacbeth reflection densitometer (manufactured by Gretagmacbeth under the trade name of RD-19I). Evaluation was repeated 5 times and an average thereof is shown in the table. When evaluation could not be performed because no ink jet recording material was prepared, “-” is indicated in the table.

### (Pigment-Ink Fixability)

The printing density was evaluated using an ink jet printer PX-G900 (manufactured by Seiko Epson Corporation). As ink cartridges, ICC33, ICM33, ICY33, ICBL33, ICR13, ICGL33, ICBK33, and ICMB33, manufactured by Seiko Epson Corporation, were used. The solid printing of black was performed, and then immediately, the formed solid print portion was rubbed with the finger once or five times, followed by performing sensorial evaluation with respect to the pigment-ink fixability.

⊚: Even when rubbed once or five times with the finger, the solid print portion of black remained a condition equivalent to that exhibited immediately after solid printing.

◯: When rubbed once with the finger, the solid print portion of black remained a condition equivalent to that exhibited immediately after solid printing. When rubbed five times with the finger, the solid print portion of black was partially removed, but there was no practical problem.

X: When rubbed once with the finger, the solid print portion of black was removed to allow a blank paper part to appear.

-: Evaluation could not be performed because no ink jet recording material was formed.

TABLE 1

| | | Adhesive for glossy layer | | | |
|---|---|---|---|---|---|
| | | | Minimum | | |
| | | Particle | film-forming | | |
| | | diameter | temperature | | Stability of |
| | Support | (nm) | (° C.) | Kind | coating liquid |
| Example 1 | B | 54 | 45 | Cationic | ◯ |
| Example 2 | B | 54 | 45 | Cationic | ◯ |
| Example 3 | B | 54 | 45 | Cationic | ◯ |
| Example 4 | B | 54 | 45 | Cationic | ◯ |
| Example 5 | B | 50 | 85 | Cationic | ◯ |
| Example 6 | B | 48 | 107 | Cationic | ◯ |
| Example 7 | B | 10 | 84 | Cationic | ◯ |
| Example 8 | B | 30 | 30 | Cationic | ◯ |
| Example 9 | B | 700 | 90 | Cationic | ◯ |
| Example 10 | B | 900 | 80 | Cationic | ◯ |
| Example 11 | C | 54 | 45 | Cationic | ◯ |
| Example 12 | C | 54 | 45 | Cationic | ◯ |
| Example 13 | B | 56 | 10 | Cationic | ◯ |
| Comparative | A | 54 | 45 | Cationic | ◯ |
| Example 1 | | | | | |
| Comparative | A | 54 | 45 | Cationic | ◯ |
| Example 2 | | | | | |
| Comparative | B | 48 | 85 | Anionic | X |
| Example 3 | | | | | |
| Comparative | B | 48 | 85 | Anionic | ◯ |
| Example 4 | | | | | |
| Comparative | B | 20 | 55 | Anionic | ◯ |
| Example 5 | | | | | |
| Comparative | B | 1200 | 65 | Anionic | ◯ |
| Example 6 | | | | | |

| | 75° | | | Ink | | |
|---|---|---|---|---|---|---|
| | specular | Image | | absorb- | Printing | Pigment ink |
| | glossiness | clarity | Cockling | ability | density | fixability |
| Example 1 | 76 | 79 | ◯ | ◯ | 2.45 | ◯ |
| Example 2 | 77 | 79 | ◯ | ◯ | 2.46 | ◯ |
| Example 3 | 78 | 79 | ◯ | ⊚ | 2.49 | ⊚ |
| Example 4 | 79 | 80 | ◯ | ⊚ | 2.50 | ⊚ |
| Example 5 | 81 | 82 | ◯ | ⊚ | 2.52 | ⊚ |
| Example 6 | 74 | 77 | ◯ | ⊚ | 2.47 | ◯ |
| Example 7 | 79 | 81 | ◯ | ◯ | 2.52 | ◯ |
| Example 8 | 77 | 78 | ◯ | ⊚ | 2.50 | ⊚ |
| Example 9 | 73 | 76 | ◯ | ⊚ | 2.43 | ⊚ |
| Example 10 | 72 | 76 | ◯ | ⊚ | 2.40 | ⊚ |
| Example 11 | 77 | 79 | ◯ | ◯ | 2.45 | ◯ |
| Example 12 | 78 | 80 | ◯ | ⊚ | 2.51 | ⊚ |
| Example 13 | 79 | 81 | ◯ | Δ | 2.50 | ◯ |
| Comparative | 72 | 74 | Δ | ⊚ | 2.36 | ⊚ |
| Example 1 | | | | | | |
| Comparative | 71 | 74 | Δ | ⊚ | 2.34 | ⊚ |
| Example 2 | | | | | | |
| Comparative | — | — | — | — | — | — |
| Example 3 | | | | | | |
| Comparative | 84 | 86 | ◯ | ◯ | 2.50 | X |
| Example 4 | | | | | | |
| Comparative | 85 | 86 | ◯ | ◯ | 2.51 | X |
| Example 5 | | | | | | |
| Comparative | 68 | 70 | ◯ | ◯ | 2.33 | X |
| Example 6 | | | | | | |

The stability of the coating liquid, 75-degree specular glossiness, image clarity, cockling, ink-absorbability, printing density, and suitability for pigment ink, of the ink jet recording material prepared in Example 14 were equivalent to those of the ink jet recording material prepared in Example 1. Although the end portions of the resin layers adhered to the surface of the glossy roll and thereby soiling occurred during preparation of the ink jet recording material in Example 1, no soiling occurred during preparation of the ink jet recording material in Example 14.

### INDUSTRIAL APPLICABILITY

The ink jet recording material obtained according to the present invention has a high-luster gloss, high-printing density, and high-storage durability, and is a recording material suitable for outputting photographic imagery of a digital camera or the like.

1. A process for producing an ink jet recording material, comprising sequentially forming an ink-receptive layer and a glossy layer on a low air-permeable or air-impermeable support or a solvent-absorptive layer superimposed on the support, wherein the glossy layer is formed by applying a coating liquid for a glossy layer, the coating liquid comprising a cationic fine pigment and a cationic emulsion type adhesive, followed by pressing using a glossy roll and a press roll while making a surface of a resultant coating liquid layer contact the glossy roll.

2. A process for producing an ink jet recording material according to claim 1, wherein the cationic fine pigment is at least one selected from the group consisting of a cationic colloidal silica with an average primary particle diameter of 3 to 100 nm, a cationic fumed silica with an average primary particle diameter of 3 to 100 nm and an average secondary particle diameter of 1 μm or less, and a fumed alumina with an average primary particle diameter of 3 to 100 nm and an average secondary particle diameter of 1 μm or less.

3. A process for producing an ink jet recording material according to claim 1 or 2, wherein the cationic emulsion type adhesive has a minimum film-forming temperature of 20 to 110° C.

4. A process for producing an ink jet recording material according to claim 1 or 2, wherein the cationic emulsion type adhesive has a particle diameter of 5 nm to 1000 nm.

5. A process for producing an ink jet recording material according claim 1 or 2, wherein the cationic emulsion type adhesive is one or at least two copolymers selected from the group consisting of a (co)polymer of (meth)acrylic ester, a styrene resin, a styrene-(meth)acrylic ester (co)polymer, a methyl methacrylate-butadiene copolymer, a styrene-butadiene copolymer, a polyether-based urethane resin, a polyester-based polyurethane resin, a polycarbonate-based polyurethane resin, an epoxy-based resin, an ethylene-vinyl acetate copolymer, an ethylene-(meth)acrylate (co) polymer, a melamine-based resin, a urea-based resin, and an olefin-based resin.

6. A process for producing an ink jet recording material according to claim 1 or 2, wherein the glossy layer comprises at least one release agent represented by the following general formula:
R₁—N⁺R₂R₃R₄X⁻ (General Formula)
(wherein R₁ represents an alkyl or alkenyl group having 10 to 18 carbon atoms, and R₂, R₃, and R₄ each represent H or an alkyl group having 1 to 4 carbon atoms, and X⁻ represents F⁻, Cl⁻, Br⁻ or I⁻).

7. A process for producing an ink jet recording material according to claim 1 or 2, wherein a coating amount of the glossy layer is within a range from 0.01 to 3 g/m².

8. A process for producing an ink jet recording material according to claim 1 or 2, wherein the support is a resin-coated paper or a plastic film.

9. A process for producing an ink jet recording material according to claim 1 or 2, wherein the support is a resin-coated paper comprising a paper base material and resin layers formed on both surfaces of the paper base material, wherein end edges in a width direction of the paper base material and the resin layers are lined up on the same plane.
